(19) United States
(12) Patent Application Publication
(10) Pub. No.: US 2025/0232925 A1
(43) Pub. Date: Jul. 17, 2025

(54) PROCESS FOR SYNTHESIZING NEODYMIUM-BASED METAL-ORGANIC FRAMEWORKS (ND-PTA-MOF) AND A HYBRID SUPERCAPACITOR SYSTEM

(71) Applicant: Central Labs-King Khalid University, Abha (SA)

(72) Inventors: Shahzad Sharif, Lahore (PK); Muhammad Shahbaz, Lahore (PK); Maham Saeed, Lahore (PK); Ayesha Shahzad, Lahore (PK); Sundas Shahzad, Lahore (PK); Onur Sahin, Sinop (TR); Shabbir Muhammad, Abha (SA); H. Algarni, Abha (SA)

(21) Appl. No.: 19/020,423

(22) Filed: Jan. 14, 2025

(51) Int. Cl. H01G 11/48; C07F 11/00; H01G 11/04

(52) U.S. Cl. CPC H01G 11/48; C07F 11/005; H01G 11/04

(57) ABSTRACT

The present invention generally relates to a process for synthesizing neodymium-based metal-organic frameworks (Nd-PTA-MOF), comprising: dissolving 166.13 mg of neodymium nitrate hexa-hydrate in 2 ml of distilled water to form a first solution; dissolving 80 mg of pyridine-2,4,6-tri-carboxylic acid (PTA) in 5 ml of distilled water to form a second solution; mixing the first solution and the second solution in a round bottom flask with magnetic stirring while heating; adding two drops of liquid ammonia to the mixture; refluxing the mixture for 2 hours at a temperature in the range of 120-150° C.; allowing the mixture to crystallize over a period of seven days to form purple-colored Nd-PTA-MOF crystals; washing the formed Nd-PTA-MOF crystals with distilled water and acetone; and fabricating an electrode for developing a hybrid supercapacitor.

### TECHNICAL FIELD

The present disclosure relates to the field of materials science and electrochemistry, particularly to the synthesis of neodymium-based metal-organic frameworks (Nd-PTA-MOF) and their application in hybrid supercapacitor systems. The invention focuses on a process for synthesizing Nd-PTA-MOF using a reflux method and explores their electrochemical properties in hybrid supercapacitor systems for enhanced energy storage and performance. The invention encompasses the preparation, characterization, and utilization of these advanced materials in various electrochemical applications, including energy storage devices, capacitors, and other related fields.

### BACKGROUND

Today, the world has become well aware of renewable energy resources due to population explosion and depletion of non-renewable resources, which has led to the demand for development of advanced storage devices. Therefore, intensive research on energy technology has become an epicenter for architecting efficient materials. It is desirable to synthesize high performance electrode material for energy storage devices. Recently, supercapacitor (SC) is targeted to tackle the issue of energy requirements. Generally, energy storage devices including supercapacitor and battery have certain limitations. SC shows low energy density and battery does not possess high power. SCs have a higher safe charging and discharging rate but low lifespan so a great deal of research is being done to increase the energy density of SCs without sacrificing their high power characteristics. The development of hybrid energy-storage devices, which aims to close the energy capacity gap between normal batteries and the power output of SCs, is a significant initiative in this field. The identification of electrode materials for supercapattery (properties of supercapacitor and battery) technology, which primarily relies on electrochemical activity and kinetic characteristics, is therefore extremely important. Hence, recent research is focused on amalgamating properties of supercapacitor and battery in a single hybrid device. Putting energy conversion and storage under one umbrella will provide high power competency for energy technology.

In the recent past, metal organic frameworks (MOFs) are employed as electrode materials in energy storage devices due to their controllable porosity, large surface area and versatile composition. MOFs are a novel family of crystalline materials that are distinguished by the coordination contacts between organic ligands and inorganic nodes. These nodes are often metal ions or clusters that possess a large capacity for charge storage. MOFs can be used directly as electrode materials because of their unique inorganic and organic hybrid structure, large specific surface area, fully exposed active sites, and variable structure. MOFs are widely used in the areas of drug delivery, chemical separation, catalysis, gas adsorption and storage, and sensing of tiny molecules and metal ions. MOFs containing transition metals (cobalt, nickel, copper, etc.) have a history of success as electrode materials in supercapacitor applications. In contrast to MOFs containing transition metals, lanthanide MOFs have been studied as electrode materials, rarely because of poor conductivity. Despite their poor conductivity, lanthanides can speed up the surface based faradic redox reactions. Nowadays, lanthanide-based MOFs materials have an electron configuration of [Xe] 4f^{N} (N=0-14) which make them useful in a variety of applications. The structure of their outer electrical layer dictates most of their chemical and physical characteristics. Lanthanides, particularly the metal organic framework of rare earth metals, are an important subject of research because of their significant bulk density and efficient redox activity, making them ideal as an active electrode material. Moreover, rare earth-ions have higher coordination numbers than d-block metal ions and can accommodate auxiliary ligands like water molecules. Without compromising their structural integrity, minor ligands can be isolated and eliminated from lanthanide-based organic frameworks. As a result, porous materials containing Lewis acidic-lanthanide ions and unsaturated coordination sites are produced.

In this regard, neodymium based MOFs exhibit promising characteristics such as rich in crystallinity, substantial porosity, and robust coordination connections between the metal and ligand. Neodymium, being lanthanide metal, is a significant, highly redox active, and naturally occurring element. It provides a long-lasting effectiveness and reliability in energy-storage devices by preventing deterioration and structural changes, and because of its strong structural qualities, resistance to corrosion, and high chemical stability, it helps to improve the specific capacity and performance of the entire system.

MOF offers limited conductivity which is closely linked with structural properties. The pore size of MOF is responsible for the charge/electron transfer that occurs in redox active MOFs through hoping (site-to-site electron transfer) and diffusion of redox active species in the electrolyte. With the increase of pore size, ions diffusion increases which enables them to approach metal redox active sites, but it also results into greater separation between redox active sites dampening electron hoping rate. Therefore, the pore size should be appropriate to improve the overall redox hopping efficiency.

To enhance the conductivity of MOFs, nature of organic linkers, nature of metal ions as well as binding modes are very important. In order to tune electronic conductivity, ligands containing redox active species promote the generation of charge carriers as well as metal centers which facilitate charge transfer from metal to ligand via enhanced orbital overlap. Moreover, electrochemical doping and R-T stacking interaction between layers also play a vital role in modeling the electronic conductivity. However, the aspect of conductivity has been locked due to inflexibility of metal ion geometry as well as nature of inert ligands such as triphenylene, phthalocyanine or benzene. Hence, the use of linker with embedded heteroatoms (such as nitrogen) have proved to increase charge transport characteristics of MOF.

Researchers reported Nd-MOF and Nd-MOF/GO using trimesic acid as organic linker which exhibited specific capacitance of 11.3 F/g and 633.5 F/g respectively, at the current density of 0.3 A/g. When the Nd-MOFs/GO composite electrode was exposed to a current density of 3 A/g, it showed cyclic stability of 86.76% after 4000 cycles and coulombic efficiency of 95.1%. These results showed that benzene tricarboxylic based MOFs shows less specific capacities which can be improved by introducing nitrogen in the benzene ring. Presence of both N and O atoms provide the multiple options for making metal-ligand bond and presence of electron pairs on the nitrogen atom enhances electro-conductivity.

In view of the foregoing discussion, it is portrayed that there is a need to have a process for synthesizing neodymium-based metal-organic frameworks (ND-PTA-MOF) and a hybrid supercapacitor system.

### BRIEF SUMMARY

The present disclosure seeks to provide a process for synthesizing neodymium-based metal-organic frameworks (ND-PTA-MOF) and a hybrid supercapacitor system for electrochemical characterization. Modern period demands development of efficient energy storage devices. Redox electrode materials for hybrid supercapacitor have stepped forward to meet the challenge. Although a variety of potential materials have been explored but metal organic frameworks (MOFs) are being focused due to their unique electrochemical characteristics and rich porosity. Herein, we have reported the first synthesis neodymium-based MOFs from pyridine-2,4,6-tricarboxylic acid (Nd-PTA-MOF) which are also structurally characterized. Electrochemical attributes of the materials are divulged by utilizing various electroanalytical techniques such as cyclic voltammetry (CV), galvanic charge-discharge (GCD) and electrochemical impedance spectroscopy (EIS). Three-electrode assembly with IM KOH shows appreciable energy storage performance so practical applications of the material are explored by fabricated it against the activated carbon. This hybrid device exhibits specific capacity of 177.43 C/g, energy density of 35.73 Wh/kg, and power density of 1179 W/kg at current density of 1 A/g. The electrode is stable with coulombic efficiency of 98.89% even after 5000 GCD cycles. Exceptional electrochemical results suggest that Nd-PTA-MOF is an efficient contender for futuristic energy storage devices.

In an embodiment, a composition for fabricating an electrode for developing a hybrid supercapacitor, comprising: 80% active material comprising Neodymium pyridine-2,4,6-tricarboxylate coordination complex (Nd-PTA-MOF): 10% carbon black: 10% polyvinylidene fluoride (PVDF) binder; and N-Methyl-2 pyrrolidone (NMP) as solvent, wherein the components are mixed to form a slurry.

In one embodiment, the neodymium-based metal-organic frameworks (Nd-PTA-MOF), comprising: a powder extract of neodymium nitrate hexa-hydrate, from 160-170 mg, in 1-4 ml of distilled water: a powder extract of pyridine-2,4,6-tri-carboxylic acid (PTA), from 70-90 mg, in 4-6 ml of distilled water; and an aqueous extract of ammonia, from 0-10 ml.

In a further embodiment, the weight amount of the neodymium nitrate hexa-hydrate, pyridine-2,4,6-tri-carboxylic acid (PTA), and distilled water, is, 166.13 mg, 80 mg, and 7 ml, respectively.

In another embodiment, a process for synthesizing neodymium-based metal-organic frameworks (Nd-PTA-MOF) is disclosed. The process includes dissolving 166.13 mg of neodymium nitrate hexa-hydrate in 2 ml of distilled water to form a first solution.

The process further includes dissolving 80 mg of pyridine-2,4,6-tri-carboxylic acid (PTA) in 5 ml of distilled water to form a second solution.

The process further includes mixing the first solution and the second solution in a round bottom flask with magnetic stirring while heating.

The process further includes adding two drops of liquid ammonia to the mixture.

The process further includes refluxing the mixture for 2 hours at a temperature in the range of 120-150° C.

The process further includes allowing the mixture to crystallize over a period of seven days to form purple-colored Nd-PTA-MOF crystals.

The process further includes washing the formed Nd-PTA-MOF crystals with distilled water and acetone.

The process further includes fabricating an electrode for developing a hybrid supercapacitor.

In one of the embodiments, the refluxing is performed using a specific heating apparatus capable of maintaining the temperature range of 120-150° C.

In a further embodiment, the addition of liquid ammonia adjusts the reaction mixture's pH, facilitating the formation of Nd-PTA-MOF.

The fabrication of the electrode, comprises the steps of: preparing a slurry comprising 80% active material comprising Neodymium pyridine-2,4,6-tricarboxylate coordination complex (Nd-PTA-MOF) crystals, 10% carbon black, and 10% PVDF binder mixed in N-Methyl-2 pyrrolidone (NMP) as solvent. Then, mixing the slurry overnight using a hot plate magnetic stirrer at 350 RPM. Then, loading the slurry onto Nickel Foam (1 cm²) by drop casting method. Then, weighing the Nickel Foam before and after loading the slurry to determine the quantity of active material. Thereafter, drying the prepared electrode for 12 hours at 60° C.

Yet, in another embodiment, a hybrid supercapacitor system using the process for electrochemical characterization is disclosed. The system further includes a three-electrode assembly including: a working electrode fabricated by preparing a slurry of 80% active material comprising Neodymium pyridine-2,4,6-tricarboxylate coordination complex (Nd-PTA-MOF) crystals, 10% carbon black, and 10% PVDF binder mixed with N-Methyl-2 pyrrolidone (NMP) and deposited onto a nickel foam substrate via a drop-casting method, wherein the nickel foam substrate is dried for 12 hours at 60° C.: a platinum plate serving as the counter electrode; and an Ag/AgCl electrode serving as the reference electrode.

The system further includes an electrolyte comprising 1M KOH solution.

The system further includes an electrochemical testing unit configured to perform linear sweep voltammetry (LSV), cyclic voltammetry (CV), galvanostatic charge-discharge (GCD), electrochemical impedance spectroscopy (EIS), and cycle stability analysis.

In one of the embodiments, the working electrode comprises a nickel foam with an active material mass loading determined by weighing the nickel foam before and after slurry deposition, with the active material mass being approximately 4 mg.

Yet, in a further embodiment, a hybrid supercapacitor utilizing a two-electrode system using the process for electrochemical characterization is disclosed. The system comprising an anode constructed of activated carbon (AC): a cathode constructed of Nd-PTA-MOF material: an electrolyte comprising 1M KOH solution; and a controller configured to calculate mass loading of the electrodes, wherein the controller further calculates specific capacitance, specific capacity, energy density, and power density.

An object of the present disclosure is to synthesize a novel Nd-PTA-MOF material using neodymium nitrate hexahydrate and pyridine-2,4,6-tricarboxylic acid (PTA) via the reflux method, which incorporates a lanthanide metal and an organic linker with nitrogen atoms to enhance electrochemical properties.

Another object of the present disclosure is to structurally characterize the synthesized Nd-PTA-MOF using advanced analytical techniques, including single-crystal X-ray diffraction (XRD), Fourier-transform infrared spectroscopy (FT-IR), and thermogravimetric analysis (TGA), ensuring a comprehensive understanding of its material properties.

Another object of the present disclosure is to demonstrate the material's energy storage capabilities in a three-electrode configuration using 1M KOH as the electrolyte, showcasing appreciable specific capacity, energy density, and power density.

Another object of the present disclosure is to explore practical applications of the Nd-PTA-MOF material by fabricating a hybrid energy storage device in combination with activated carbon, assessing its potential for real-world use.

Yet another object of the present invention is to deliver an expeditious and cost-effective process for synthesizing neodymium-based metal-organic frameworks (Nd-PTA-MOF).

To further clarify the advantages and features of the present disclosure, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF FIGURES

These and other features, aspects, and advantages of the present disclosure will become better understood when the following detailed description is read concerning the accompanying drawings in which like characters represent like parts throughout the drawings, wherein;

FIG. 1 illustrates a flow chart of a process for synthesizing neodymium-based metal-organic frameworks (Nd-PTA-MOF) in accordance with an embodiment of the present disclosure;

FIG. 2 illustrates a block diagram of a hybrid supercapacitor system for electrochemical characterization in accordance with an embodiment of the present disclosure;

FIG. 3 illustrates a schematic illustration for the synthesis of Nd-PTA-MOF by using reflux method in accordance with an embodiment of the present disclosure;

FIG. 4A illustrates a molecular structure of complex showing the atom numbering scheme;

FIG. 4B illustrates a schematic view of 3D propagation in complex;

FIG. 4C illustrates a schematic polyhedral;

FIG. 5A illustrates CV of Nd-PTA-MOF at various scan rates;

FIG. 5B illustrates R² value of Nd-PTA-MOF;

FIG. 5C illustrates Graph of linear fitting between log of peak current (ip) and log of scan rate;

FIG. 5D illustrates Percentage of capacitive and diffusive contribution showing by bar graph;

FIG. 5E illustrates Diffusive and capacitive contribution of Nd-PTA-MOF at scan rate of 5 mV/s;

FIG. 5F illustrates Diffusive and capacitive contribution of Nd-PTA-MOF at scan rate of 80 mV/s;

FIG. 6A illustrates GCD of Nd-PTA-MOF at various current densities (0.75-7 A/g);

FIG. 6B illustrates Relationship of specific capacities with different current densities;

FIG. 6C illustrates Relationship of specific capacitances with different current densities;

FIG. 6D illustrates EIS of Nd-PTA-MOF in accordance with an embodiment of the present disclosure;

FIG. 7A illustrates Schematic representation of the assembled hybrid device,

FIG. 7B illustrates CV's of Nd-PTA-MOF and AC electrodes, individually;

FIG. 7C illustrates CV of Nd-PTA-MOF//AC at various scan rate;

FIG. 7D illustrates Bar graph showing percentage contribution of diffusive and capacitive contribution;

FIG. 7E illustrates Diffusive and capacitive contribution of Nd-PTA-MOF//AC at the scan rate of 10 mV/s;

FIG. 7F illustrates Diffusive and capacitive contribution of Nd-PTA-MOF//AC at the scan rate of 100 mV/s in accordance with an embodiment of the present disclosure;

FIG. 8A illustrates GCD of hybrid device (Nd-PTA-MOF//AC) with different current densities;

FIG. 8B illustrates Comparison of specific capacities and current densities;

FIG. 8C illustrates Comparison of specific capacities and current densities;

FIG. 8D illustrates Number of cycles versus Coulombic efficiency of Nd-PTA-MOF//AC hybrid device;

FIG. 8E illustrates EIS Spectrum of Nd-PTA-MOF//AC before stability and after stability;

FIG. 8F Comparison of energy densities and power densities at various current densities in accordance with an embodiment of the present disclosure;

FIG. 9 illustrates FTIR spectra of Gd-PDA-MOF in accordance with an embodiment of the present disclosure;

FIG. 10 illustrates TGA of Gd-PDA-MOF in accordance with an embodiment of the present disclosure;

FIG. 11 illustrates Simulated XRD diffractogram of Gd-PDA-MOF in accordance with an embodiment of the present disclosure;

FIG. 12 illustrates a Table depicting comparative electrochemical analysis of current work with already reported materials in accordance with an embodiment of the present disclosure;

FIG. 13 illustrates a Table depicting crystal data and structure refinement parameters for complex in accordance with an embodiment of the present disclosure;

FIG. 14 illustrates a Table depicting selected bond distances in the complex (A) in accordance with an embodiment of the present disclosure; and

FIG. 15 illustrates a Table depicting Hydrogen-bond parameters for complex (Å, °) in accordance with an embodiment of the present disclosure.

Further, skilled artisans will appreciate those elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

To promote an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods or processes, and examples provided herein are illustrative only and not intended to be limiting.

Embodiments of the present disclosure will be described below in detail concerning the accompanying drawings.

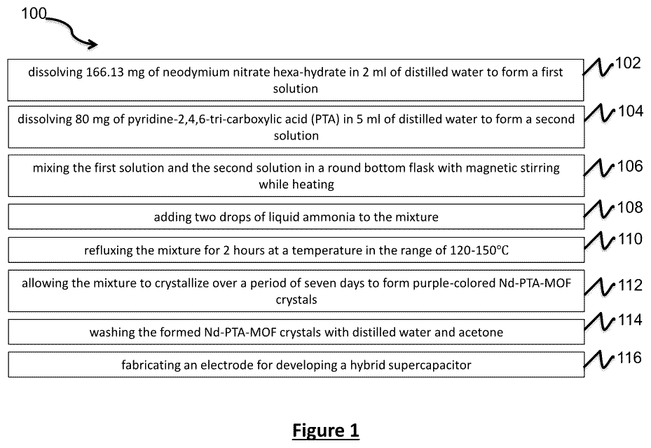

Referring to FIG. 1, a flow chart of a process for synthesizing neodymium-based metal-organic frameworks (Nd-PTA-MOF) is illustrated in accordance with an embodiment of the present disclosure. At step 102, process 100 includes dissolving 166.13 mg of neodymium nitrate hexa-hydrate in 2 ml of distilled water to form a first solution.

At step 104, process 100 includes dissolving 80 mg of pyridine-2,4,6-tri-carboxylic acid (PTA) in 5 ml of distilled water to form a second solution.

At step 106, process 100 includes mixing the first solution and the second solution in a round bottom flask with magnetic stirring while heating.

At step 108, process 100 includes adding two drops of liquid ammonia to the mixture.

At step 110, process 100 includes refluxing the mixture for 2 hours at a temperature in the range of 120-150° C.

At step 112, process 100 includes allowing the mixture to crystallize over a period of seven days to form purple-colored Nd-PTA-MOF crystals.

At step 114, process 100 includes washing the formed Nd-PTA-MOF crystals with distilled water and acetone.

At step 116, process 100 includes fabricating an electrode for developing a hybrid supercapacitor.

In one of the embodiments, the refluxing is performed using a specific heating apparatus capable of maintaining the temperature range of 120-150° C.

In a further embodiment, the addition of liquid ammonia adjusts the reaction mixture's pH, facilitating the formation of Nd-PTA-MOF.

The fabrication of the electrode, comprises the steps of: preparing a slurry comprising 80% active material comprising Neodymium pyridine-2,4,6-tricarboxylate coordination complex (Nd-PTA-MOF) crystals, 10% carbon black, and 10% PVDF binder mixed in N-Methyl-2 pyrrolidone (NMP) as solvent. Then, mixing the slurry overnight using a hot plate magnetic stirrer at 350 RPM. Then, loading the slurry onto Nickel Foam (1 cm²) by drop casting method. Then, weighing the Nickel Foam before and after loading the slurry to determine the quantity of active material. Thereafter, drying the prepared electrode for 12 hours at 60° C.

In an embodiment, the neodymium nitrate hexa-hydrate is dissolved in distilled water at a temperature in the range of 25-40° C., wherein the pyridine-2,4,6-tricarboxylic acid (PTA) is preheated to a temperature in the range of 50-70° C. before dissolving, and wherein the ammonia is added dropwise under continuous stirring at a rate of 1-2 drops per minute, wherein the crystallization step is carried out in a controlled environment chamber, wherein the relative humidity is maintained between 50% and 70%, and wherein the temperature is gradually reduced from 25° C. to room temperature over a period of 48-72 hours, and wherein the slurry preparation involves sequentially adding carbon black to the active material before introducing the PVDF binder, wherein the PVDF binder is dissolved in NMP at a concentration of 8-12% by weight, and wherein the final mixture is subjected to ultrasonication for 15-30 minutes to ensure homogeneity. In one embodiment, the process begins with the dissolution of neodymium nitrate hexa-hydrate in distilled water at a temperature range of 25-40° C. This controlled temperature range ensures that the neodymium salt dissolves effectively without causing decomposition or the formation of unwanted side products. The dissolution step is crucial for ensuring that the neodymium ions are uniformly available for subsequent reactions. By controlling the temperature within this range, it is also possible to avoid excessive evaporation of water, ensuring that the correct stoichiometry is maintained for the synthesis.

Pyridine-2,4,6-tricarboxylic acid (PTA), another key reactant, is preheated to a temperature range of 50-70° C. before being dissolved. Preheating the PTA to this range ensures that the solid acid dissolves rapidly in water, promoting complete solubilization. This step is particularly important as the solubility of PTA increases with temperature, thus facilitating its uniform distribution in the reaction mixture and enhancing the rate at which the Nd-PTA-MOF crystals can form.

Ammonia is added dropwise to the solution at a rate of 1-2 drops per minute while stirring continuously. This controlled addition is essential to maintain the pH of the reaction mixture within an optimal range for the formation of Nd-PTA-MOF. The gradual addition of ammonia ensures that the reaction does not experience sudden pH shifts, which could disrupt the formation of the metal-organic framework (MOF). By controlling the rate of ammonia addition, the reaction environment is kept stable, which aids in achieving a high-quality crystalline structure for the final Nd-PTA-MOF.

Once the reaction mixture is prepared, it is allowed to crystallize in a controlled environment chamber. The chamber's relative humidity is maintained between 50% and 70%, which is critical for promoting the formation of well-defined Nd-PTA-MOF crystals. Humidity control helps prevent excessive evaporation of solvent and ensures that the crystallization process occurs uniformly, leading to larger and more homogeneous crystals. The temperature within the chamber is gradually reduced from 25° C. to room temperature over a period of 48-72 hours. This slow cooling process is essential for allowing the crystals to grow properly, ensuring that they have the appropriate size and structural integrity for use in electrode fabrication.

After the crystallization process, the slurry preparation for electrode fabrication begins. In this embodiment, carbon black is sequentially added to the active material, Nd-PTA-MOF, before the introduction of the polyvinylidene fluoride (PVDF) binder. The carbon black is used as a conductive additive to enhance the electrical conductivity of the final electrode. By adding carbon black before the binder, the dispersion of the carbon in the slurry is more efficient, as the carbon black particles can more easily adhere to the active material. The PVDF binder, which is dissolved in N-Methyl-2-pyrrolidone (NMP) at a concentration of 8-12% by weight, is introduced after the carbon black to form a homogeneous mixture. The binder is crucial for ensuring that the active material adheres to the electrode substrate, while also maintaining the structural integrity of the electrode during charge-discharge cycles.

To further ensure homogeneity, the final mixture is subjected to ultrasonication for 15-30 minutes. This step helps to disperse any agglomerates of the active material or carbon black, ensuring a uniform slurry. The ultrasonication process also aids in breaking down any bubbles or air pockets that may form, ensuring that the slurry is free of defects. This homogeneous slurry is then ready for application to the electrode substrate, ensuring optimal performance when the electrode is used in a hybrid supercapacitor.

In an embodiment, the refluxing is performed in a closed-loop reflux apparatus equipped with a reflux condenser, wherein the apparatus is purged with nitrogen gas prior to heating, and wherein the temperature gradient across the reaction mixture is maintained within ±5° C. of the set range, and wherein the neodymium nitrate hexa-hydrate is sourced with a purity of at least 99.9%, wherein the pyridine-2,4,6-tricarboxylic acid is recrystallized from ethanol before use, and wherein the distilled water used in the synthesis has a conductivity below 2 μS/cm. In one embodiment, the refluxing step is performed in a closed-loop reflux apparatus that is equipped with a reflux condenser. This setup ensures that any evaporated solvents are efficiently condensed and returned to the reaction mixture, thereby preventing the loss of solvents during the heating process and maintaining the volume of the reaction mixture. The closed-loop design also minimizes the risk of contamination from external sources, providing a controlled environment for the synthesis of the Neodymium pyridine-2,4,6-tricarboxylate coordination complex (Nd-PTA-MOF).

Before heating begins, the apparatus is purged with nitrogen gas. This is a critical step to prevent the presence of oxygen, which could lead to the formation of undesirable oxidation products or interfere with the desired reaction. The nitrogen purging ensures an inert atmosphere, promoting the stability of the reaction components and the formation of high-quality MOF crystals. This step is especially important for reactions involving metal salts such as neodymium nitrate hexa-hydrate, as oxygen can affect the solubility and reactivity of metal ions in solution. To ensure that the reaction proceeds under optimal conditions, the temperature gradient across the reaction mixture is tightly controlled within +5° C. of the set temperature range. This precise temperature control is essential for maintaining a consistent reaction rate and ensuring that the Nd-PTA-MOF forms with the desired structure and purity. A temperature gradient that is too large could result in uneven heating, leading to incomplete reactions or the formation of poorly crystalline products. By maintaining the temperature within this narrow range, the reaction mixture can achieve optimal conditions for crystal growth and the formation of the metal-organic framework.

In this embodiment, the neodymium nitrate hexa-hydrate used in the synthesis has a purity of at least 99.9%. This high purity is crucial to ensure that no impurities interfere with the synthesis of the Nd-PTA-MOF, as even trace amounts of contaminants can adversely affect the quality of the final product. The use of high-purity neodymium nitrate ensures that the neodymium ions in the solution are fully available for coordination with the PTA, leading to the formation of a well-defined, high-quality MOF structure.

Furthermore, the pyridine-2,4,6-tricarboxylic acid (PTA) is recrystallized from ethanol before use. Recrystallization is a purification method that removes impurities from the PTA, ensuring that only pure PTA is used in the synthesis. Impurities in the PTA could disrupt the coordination of the PTA ligands with the neodymium ions, leading to defective or incomplete crystal formation. By recrystallizing the PTA, its purity is guaranteed, which directly contributes to the formation of high-quality Nd-PTA-MOF crystals.

Additionally, the distilled water used in the synthesis has a conductivity below 2 μS/cm. This low conductivity ensures that the water is sufficiently pure, with minimal ionic contamination that could interfere with the reaction. Impurities in the water could alter the pH or affect the solubility of the reagents, potentially leading to inconsistencies in the reaction. By using water with such low conductivity, the reaction environment is kept as clean and controlled as possible, promoting the formation of high-quality crystals. In an embodiment, the refluxing is performed using a heating apparatus with a temperature controller, wherein the temperature is maintained within a tolerance of +3° C., and wherein the reflux condenser has a cooling capacity sufficient to maintain condensation of all evaporated solvent within the set range of 120-150° C., and wherein the heating is applied gradually at a rate of 1-2° C. per minute to avoid sudden temperature changes, and wherein the apparatus is equipped with an inert gas inlet to ensure an oxygen-free environment during the reaction. In one embodiment, the refluxing step is performed using a heating apparatus that is equipped with a precise temperature controller, which ensures that the temperature is maintained within a tolerance of +3° C. This level of precision is crucial to achieve consistent and reproducible results in the synthesis of the Neodymium pyridine-2,4,6-tricarboxylate coordination complex (Nd-PTA-MOF). By tightly controlling the temperature within this narrow range, the reaction mixture remains at an optimal temperature for the entire duration of the reflux, which allows for the desired crystallization of the Nd-PTA-MOF without the risk of overheating or underheating, both of which could result in incomplete reactions or poor-quality products.

The reflux condenser is specifically designed with a cooling capacity that is sufficient to maintain the condensation of all evaporated solvent within the set temperature range of 120-150° C. The condenser plays a critical role in ensuring that the solvent, once evaporated, is returned to the reaction mixture. A condenser with adequate cooling capacity ensures that no solvent is lost during the reflux process, maintaining the reaction volume and preventing any disruption to the reaction equilibrium. This allows for efficient heat transfer and the continued formation of Nd-PTA-MOF crystals. The efficient condensation and recovery of solvent also contribute to the sustainability and cost-effectiveness of the process by minimizing solvent waste.

Heating is applied gradually at a rate of 1-2° C. per minute, which is an important measure to prevent sudden temperature fluctuations that could negatively impact the reaction. Rapid heating can lead to thermal shock, which might cause uneven heating in the reaction mixture, disrupt the formation of the crystal structure, or even cause the decomposition of sensitive reactants. By applying heat gradually, the system ensures that the temperature increases uniformly, allowing the reaction to proceed smoothly and steadily. This gradual approach also helps the reaction mixture to equilibrate thermally, leading to better control over the formation of the desired metal-organic framework.

In this embodiment, the apparatus is also equipped with an inert gas inlet to ensure an oxygen-free environment during the reaction. The presence of oxygen could lead to unwanted side reactions, such as oxidation of the metal center (neodymium) or the ligands (pyridine-2,4,6-tricarboxylic acid), which could hinder the formation of the desired Nd-PTA-MOF. By introducing an inert gas, such as nitrogen or argon, into the reaction vessel, the reaction is conducted in an oxygen-free environment that helps prevent oxidative degradation of the reagents and ensures the integrity of the synthesis process. The use of an inert gas inlet also helps to maintain a stable environment for the reaction, promoting the growth of high-quality crystals.

The technical efficacy of this embodiment lies in the precise control of various factors, such as temperature, solvent recovery, and the reaction atmosphere. The combination of a temperature-controlled heating system with a reflux condenser ensures that the reaction is performed under optimal thermal conditions, while the gradual heating prevents thermal shock and guarantees uniform temperature distribution. Additionally, the inert gas inlet protects the reaction from oxygen interference, which is crucial for the formation of high-quality Nd-PTA-MOF crystals.

In an embodiment, the crystallization occurs in a darkened chamber to prevent photodegradation of the Nd-PTA-MOF, wherein the chamber temperature is maintained at 25° C. for the first 24 hours, and wherein the humidity level within the crystallization chamber is controlled with a dehumidifier to maintain a constant relative humidity of 60%, and wherein the crystallized Nd-PTA-MOF is gently washed with distilled water followed by acetone to remove any residual solvent, and wherein the washed crystals are dried under a stream of nitrogen gas at room temperature for 6-8 hours. In one embodiment, the crystallization of the Neodymium pyridine-2,4,6-tricarboxylate coordination complex (Nd-PTA-MOF) takes place in a darkened chamber. This precaution is taken to prevent photodegradation, which can be a concern when sensitive materials like metal-organic frameworks (MOFs) are exposed to light. The exposure to light, particularly ultraviolet (UV) radiation, could cause the degradation or structural alteration of the MOF, affecting its performance in subsequent applications. By carrying out the crystallization in a darkened chamber, the integrity of the Nd-PTA-MOF is preserved, ensuring that the framework remains intact and functional for its intended use, such as in energy storage devices like supercapacitors.

During the first 24 hours of crystallization, the temperature within the chamber is maintained at a constant 25° C. This stable temperature control is critical in the early stages of crystal formation, as fluctuations in temperature could lead to the formation of small, irregular crystals or even prevent crystallization altogether. Maintaining the temperature at 25° C. for the initial period helps to ensure that the Nd-PTA-MOF crystals grow uniformly and without stress, which is essential for achieving high-quality, well-formed crystals that are suitable for electrode fabrication or other high-performance applications.

The relative humidity within the crystallization chamber is carefully controlled with the use of a dehumidifier, ensuring that it is maintained at a constant level of 60%. Humidity plays an important role in the crystallization process, as excessive moisture can lead to incomplete or poorly formed crystals, while low humidity can hinder the crystallization process altogether. By maintaining a relative humidity of 60%, the conditions are optimized for crystal growth, which helps in the formation of large, well-defined Nd-PTA-MOF crystals. This controlled environment ensures that the crystallization is both efficient and reproducible, which is essential for the scalability and consistency of the process.

Once the crystals have formed, they are gently washed with distilled water followed by acetone to remove any residual solvent that may have remained from the synthesis process. This washing step is necessary to ensure that any unreacted starting materials, solvents, or impurities are removed from the surface of the crystals, which could otherwise affect their purity and performance. The use of distilled water ensures that no additional ions or impurities are introduced during the washing process, while acetone is effective at removing any organic solvents that may be present.

After washing, the Nd-PTA-MOF crystals are dried under a stream of nitrogen gas at room temperature for a period of 6-8 hours. Drying under nitrogen ensures that any remaining solvent is removed from the crystals without subjecting them to high temperatures, which could cause the structure of the MOF to break down. The use of nitrogen gas facilitates a gentle and controlled drying process by providing an inert environment that prevents oxidation or other reactions that could alter the properties of the MOF. This drying step is crucial for obtaining the final, pure Nd-PTA-MOF product that is ready for use in electrode fabrication or other applications.

In an embodiment, the slurry preparation further comprises the addition of a small quantity of a conductive additive selected from the group consisting of graphene oxide and carbon nanotubes, wherein the conductive additive is added at a concentration between 1% and 5% by weight, and wherein the slurry is heated at 50° C. during mixing to reduce the viscosity of the solvent, and wherein the mixture is subjected to an ultrasonic treatment at a frequency of 20-40 kHz for 15 minutes to enhance dispersion of the active material, and wherein the PVDF binder is added dropwise to the slurry to prevent premature gelation. In one embodiment, the slurry preparation for fabricating the electrode involves the addition of a small quantity of a conductive additive, which is selected from the group consisting of graphene oxide and carbon nanotubes. The conductive additive is introduced at a concentration between 1% and 5% by weight. The addition of these conductive materials plays a crucial role in enhancing the electrical conductivity of the slurry, and ultimately, the electrode. Both graphene oxide and carbon nanotubes are known for their excellent conductivity, which significantly improves the overall performance of the final electrode. The incorporation of these additives ensures that the active material, which is the Nd-PTA-MOF, can efficiently conduct charge and support fast electron transfer during charge and discharge cycles in supercapacitors or other energy storage devices. The specific concentration range of 1% to 5% by weight is optimized to ensure that sufficient conductive pathways are provided without excessively diluting the active material or adversely affecting the electrode's structure.

The slurry is then heated to 50° C. during the mixing process. This controlled heating step is essential for reducing the viscosity of the solvent, which, in turn, improves the ease and efficiency of mixing. By reducing the viscosity, the active material and conductive additives can be more easily dispersed throughout the slurry, ensuring that the mixture remains homogeneous. This improved fluidity also aids in preventing clumping of the particles, ensuring that each particle is properly coated with the binder when it is introduced. The controlled temperature of 50° C. ensures that the slurry maintains a proper consistency for both effective mixing and uniform application onto the electrode substrate.

Once the slurry is prepared, it is subjected to ultrasonic treatment at a frequency of 20-40 kHz for 15 minutes. This ultrasonic treatment is a key step in enhancing the dispersion of the active material (Nd-PTA-MOF) within the slurry. Ultrasonication helps break apart any agglomerates of the active material, ensuring that the particles are well-dispersed and evenly distributed throughout the slurry. This process enhances the homogeneity of the slurry, which is important for achieving consistent electrode performance. It also helps to improve the adhesion between the active material and the conductive additive, resulting in a more stable and effective electrode.

The PVDF binder is added dropwise to the slurry to prevent premature gelation. The binder plays a critical role in ensuring the mechanical integrity and stability of the electrode. However, if it is added too quickly or in excess, it could cause the slurry to gel prematurely, making it difficult to achieve an even distribution of the active material and conductive additives. By adding the PVDF binder dropwise, the rate of gelation is carefully controlled, ensuring that the binder is uniformly distributed throughout the slurry and that the slurry remains workable. This gradual addition helps to achieve the right balance of binder content, which is essential for maintaining the structural integrity of the electrode while ensuring that the active material is effectively bound to the substrate during the fabrication process.

In an embodiment, the electrode fabrication further comprises the step of compressing the loaded Nickel Foam after drying, wherein the compression is applied at a force of 50-100 N for 5 minutes to ensure uniform contact between the active material and the substrate, and wherein the electrode is then subjected to a thermal treatment at 80° C. for 2 hours under vacuum to remove any residual solvents, and wherein the final electrode is characterized by a surface area greater than 1.2 cm², and wherein the specific capacitance of the electrode is tested in a two-electrode configuration using an aqueous electrolyte.

In one embodiment, the electrode fabrication process includes the additional step of compressing the loaded Nickel Foam after it has been dried. This compression is applied at a force of 50-100 N for 5 minutes. The application of this controlled compression force is critical for ensuring uniform contact between the active material, which is the Nd-PTA-MOF, and the Nickel Foam substrate. By applying pressure, the active material is compacted against the substrate, increasing the mechanical bonding between the electrode and the substrate while also improving the electrical contact. Uniform contact between the active material and the substrate ensures that the electrode has consistent electrical conductivity throughout its surface, which is essential for achieving optimal performance in energy storage applications. Additionally, this compression helps eliminate air gaps or inconsistencies in the active material layer, which can improve the overall efficiency and stability of the electrode during charge and discharge cycles.

After the compression step, the electrode is subjected to a thermal treatment at 80° C. for 2 hours under vacuum. This thermal treatment serves multiple purposes: it helps to remove any residual solvents or moisture that may remain in the electrode after the slurry preparation and drying steps. Residual solvents or moisture could interfere with the performance of the electrode, leading to reduced conductivity or stability. The vacuum environment is particularly important because it ensures that any trapped solvents are effectively evaporated and removed from the electrode, preventing the formation of bubbles or unwanted chemical interactions. The vacuum also promotes better solvent evaporation by reducing the boiling point of the solvents, ensuring thorough removal without affecting the integrity of the electrode material.

The final electrode is characterized by a surface area greater than 1.2 cm². A larger surface area is important for improving the electrochemical performance of the electrode, as it provides more sites for charge storage during the charging and discharging cycles of the energy storage device. The increased surface area facilitates better interaction between the electrolyte and the active material, which is crucial for high specific capacitance, fast charge/discharge rates, and overall efficiency in supercapacitors or hybrid capacitors. The surface area greater than 1.2 cm² ensures that the electrode is optimized for high-performance applications, providing enough area for efficient energy storage and transfer.

Finally, the specific capacitance of the electrode is tested in a two-electrode configuration using an aqueous electrolyte. Specific capacitance is a key performance indicator of an electrode in energy storage devices, as it measures the ability of the electrode to store charge. The two-electrode configuration is commonly used for this testing, as it simulates the practical setup of a supercapacitor or similar energy storage device. The aqueous electrolyte provides a stable ionic medium for charge transfer, and testing the specific capacitance under these conditions allows for an accurate assessment of the electrode's performance. This step is essential for verifying that the electrode meets the required specifications for efficient energy storage and can perform reliably in practical applications.

In an embodiment, the addition of liquid ammonia is done in small portions, wherein each portion is added every 2-3 minutes, and wherein the pH of the reaction mixture is monitored continuously using a pH meter to ensure a final pH of 7.0-7.5, and wherein the pH adjustment ensures the formation of a well-structured Nd-PTA-MOF, and wherein the ammonia solution is prepared fresh prior to use, and wherein the ammonia is of analytical grade with a purity of at least 99%. In one embodiment, the addition of liquid ammonia to the reaction mixture is done in small portions, with each portion being added every 2-3 minutes. This gradual addition is important for maintaining the controlled pace of the reaction, preventing any sudden shifts in the reaction environment that could lead to undesirable by-products or incomplete formation of the Neodymium pyridine-2,4,6-tricarboxylate coordination complex (Nd-PTA-MOF). By adding the ammonia slowly, the reaction mixture is given enough time to adjust and stabilize at each stage, ensuring that the pH of the solution changes gradually and in a controlled manner. This helps to achieve a consistent and uniform reaction environment, which is critical for the precise formation of the Nd-PTA-MOF structure.

The pH of the reaction mixture is continuously monitored using a pH meter during the addition of ammonia. This continuous monitoring is essential to ensure that the pH stays within the optimal range of 7.0 to 7.5. The pH is a crucial parameter in the synthesis of the Nd-PTA-MOF, as it directly affects the solubility of the reactants and the coordination between the neodymium ions and the pyridine-2,4,6-tricarboxylic acid (PTA). By maintaining the pH in this specific range, the reaction conditions are optimized to facilitate the formation of a well-structured Nd-PTA-MOF. A pH that is too high or too low can lead to the formation of poorly structured or incomplete MOF crystals, which would result in a lower yield or suboptimal performance of the final material.

The pH adjustment through the controlled addition of ammonia ensures that the coordination chemistry between the neodymium ions and the PTA ligand proceeds efficiently, leading to the formation of a well-ordered and crystalline Nd-PTA-MOF. This well-structured material is essential for its intended use in energy storage devices such as supercapacitors. The quality of the MOF structure directly impacts its electrochemical performance, such as its specific capacitance, stability, and charge/discharge behavior. Therefore, precise pH control plays a significant role in ensuring that the resulting Nd-PTA-MOF has the desired structural integrity and electrochemical properties.

Furthermore, the ammonia solution used in the process is prepared fresh prior to use. This ensures that the ammonia solution is at its highest possible purity and free from degradation products that may form over time, which could negatively affect the reaction. The ammonia used is of analytical grade with a purity of at least 99%. The high purity of the ammonia is essential to avoid introducing contaminants into the reaction mixture, which could interfere with the synthesis of the Nd-PTA-MOF or alter the properties of the final product. Using high-purity ammonia ensures that the synthesis process proceeds smoothly, with minimal side reactions, and that the final material meets the desired specifications.

In an embodiment, the distilled water used in the synthesis is filtered through a 0.22 μm membrane filter to remove any particulate matter, and wherein the temperature of the distilled water is kept constant during dissolution at 30° C. using a water bath, and wherein the neodymium nitrate hexa-hydrate is dissolved slowly to avoid localized overheating, and wherein the pyridine-2,4,6-tricarboxylic acid (PTA) solution is stirred at 400 RPM for at least 30 minutes to ensure complete dissolution before the second solution is added. In one embodiment, the distilled water used in the synthesis is filtered through a 0.22 μm membrane filter to remove any particulate matter. This filtration step is critical to ensure the purity of the distilled water, as any contaminants, such as dust or other particles, could interfere with the chemical reactions during the synthesis process. Particulate matter in the water could potentially act as nucleation sites, leading to the formation of unwanted by-products or non-uniform structures in the resulting Neodymium pyridine-2,4,6-tricarboxylate coordination complex (Nd-PTA-MOF). By filtering the distilled water, the synthesis process is initiated with a clean solvent, ensuring that the reaction occurs under controlled and contaminant-free conditions.

The temperature of the distilled water is carefully maintained at a constant 30° C. during the dissolution of the neodymium nitrate hexa-hydrate. This is achieved by using a water bath, which provides a stable and controlled heating environment. The controlled temperature ensures that the neodymium nitrate hexa-hydrate dissolves efficiently, as temperature can significantly affect the solubility of salts. By maintaining the temperature at 30° C., the solubility of neodymium nitrate hexa-hydrate is optimized, allowing for a smooth dissolution process without any temperature-induced issues such as rapid crystallization or degradation of the material. This step is important for achieving a homogeneous and well-mixed solution that is crucial for the subsequent synthesis of the Nd-PTA-MOF.

Additionally, the neodymium nitrate hexa-hydrate is dissolved slowly to avoid localized overheating. If the salt is added too quickly or at too high a temperature, it can lead to localized areas of high concentration, which could cause premature precipitation or the formation of undesirable by-products. By dissolving the neodymium nitrate hexa-hydrate slowly, the dissolution process is controlled, ensuring that the salt dissolves evenly throughout the solvent. This gradual dissolution also minimizes the risk of localized overheating, which can destabilize the reaction or result in incomplete dissolution, leading to a lower quality of the final product.

Once the neodymium nitrate hexa-hydrate has dissolved completely, the pyridine-2,4,6-tricarboxylic acid (PTA) solution is prepared. This PTA solution is stirred at 400 RPM for at least 30 minutes to ensure complete dissolution of the PTA in the solvent. The stirring speed of 400 RPM is sufficient to create a homogeneous solution, facilitating the even distribution of the PTA throughout the solvent. The extended stirring time of at least 30 minutes ensures that the PTA is fully dissolved, preventing any undissolved particles from remaining in the solution. Complete dissolution of PTA is crucial for the subsequent formation of the Nd-PTA-MOF, as undissolved PTA could affect the stoichiometry and result in an incomplete or poorly structured framework.

In an embodiment, a composition for fabricating an electrode for developing a hybrid supercapacitor is provided. The composition comprising: 80% active material comprising Neodymium pyridine-2,4,6-tricarboxylate coordination complex (Nd-PTA-MOF): 10% carbon black: 10% polyvinylidene fluoride (PVDF) binder; and N-Methyl-2 pyrrolidone (NMP) as solvent, wherein the components are mixed to form a slurry.

In one embodiment, the neodymium-based metal-organic frameworks (Nd-PTA-MOF), comprising: a powder extract of neodymium nitrate hexa-hydrate, from 160-170 mg, in 1-4 ml of distilled water: a powder extract of pyridine-2,4,6-tri-carboxylic acid (PTA), from 70-90 mg, in 4-6 ml of distilled water; and an aqueous extract of ammonia, from 0-10 ml.

In a further embodiment, the weight amount of the neodymium nitrate hexa-hydrate, pyridine-2,4,6-tri-carboxylic acid (PTA), and distilled water, is, 166.13 mg, 80 mg, and 7 ml, respectively.

In an embodiment, the composition involves the use of carbon black with a particle size in the range of 50-100 nm. The specific particle size of the carbon black is crucial for enhancing the conductivity and stability of the electrode material. Smaller particle sizes ensure a larger surface area, which facilitates better interaction with the active material and improves the overall electrochemical performance of the electrode. Carbon black, being conductive, helps to distribute the charge more efficiently during charge-discharge cycles, improving the efficiency and stability of the energy storage device. Additionally, the PVDF binder used in the composition has a molecular weight in the range of 400,000-500,000 g/mol. The molecular weight of the binder is significant for its role in binding the active material to the substrate while ensuring flexibility and mechanical strength. Higher molecular weight binders tend to form stronger polymer networks, which enhance the mechanical integrity of the electrode, particularly during cycling. The PVDF binder with a molecular weight in this range ensures that the electrode retains its structural stability over time while providing the necessary mechanical strength to withstand repeated charge and discharge cycles without losing its performance.

Furthermore, the N-Methyl-2-pyrrolidone (NMP) solvent is used at a ratio of 5-10 ml per gram of the total solids in the slurry. The solvent-to-solids ratio plays a key role in controlling the viscosity and flow characteristics of the slurry. A higher ratio of solvent ensures that the slurry remains fluid enough to be applied uniformly to the substrate, whereas a lower ratio could result in a paste-like consistency that may be difficult to handle. The chosen range ensures that the slurry has optimal consistency for easy application while ensuring that the solid components (active material, carbon black, and binder) are well-dispersed and evenly distributed in the slurry, resulting in a uniform and consistent electrode material.

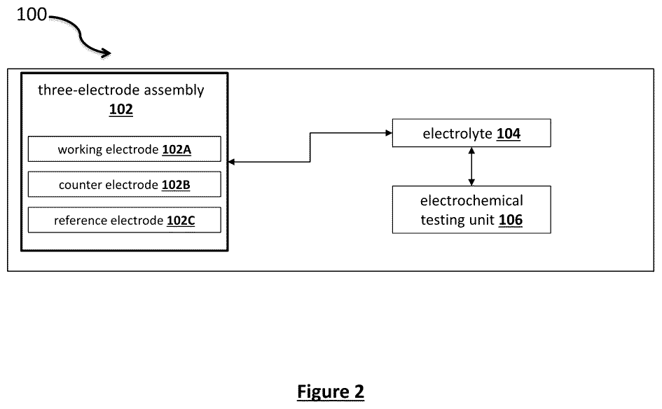

FIG. 2 illustrates a block diagram of a hybrid supercapacitor system for electrochemical characterization in accordance with an embodiment of the present disclosure. The system (200) further includes a three-electrode assembly (102) including a working electrode (102A) fabricated by preparing a slurry of 80% active material comprising Neodymium pyridine-2,4,6-tricarboxylate coordination complex (Nd-PTA-MOF) crystals, 10% carbon black, and 10% PVDF binder mixed with N-Methyl-2 pyrrolidone (NMP) and deposited onto a nickel foam substrate via a drop-casting method, wherein the nickel foam substrate is dried for 12 hours at 60° C., a platinum plate serving as the counter electrode (102B), and an Ag/AgCl electrode serving as the reference electrode (102C).

In an embodiment, an electrolyte (104) comprising 1M KOH solution.

In an embodiment, an electrochemical testing unit (106) configured to perform linear sweep voltammetry (LSV), cyclic voltammetry (CV), galvanostatic charge-discharge (GCD), electrochemical impedance spectroscopy (EIS), and cycle stability analysis.

In one of the embodiments, the working electrode comprises a nickel foam with an active material mass loading determined by weighing the nickel foam before and after slurry deposition, with the active material mass being approximately 4 mg.

In an implementation, the present invention provides a process comprising providing a hybrid supercapacitor system for electrochemical characterization, by: providing a three-electrode assembly including: fabricating the electrode using the process of claim 1, said electrode having a composition comprising 80% active material comprising Neodymium pyridine-2,4,6-tricarboxylate coordination frameworks (Nd-PTA-MOF): 10% carbon black; 10% polyvinylidene fluoride (PVDF) binder; and N-Methyl-2 pyrrolidone (NMP) as solvent; providing a counter electrode comprising of a platinum plate: providing a reference electrode comprising of an Ag/AgCl electrode; providing an electrolyte comprising 1M KOH solution; and providing an electrochemical testing unit configured to perform linear sweep voltammetry (LSV), cyclic voltammetry (CV), galvanostatic charge-discharge (GCD), electrochemical impedance spectroscopy (EIS), and cycle stability analysis.

In an implementation, the working electrode comprises a nickel foam with an active material mass loading determined by weighing the nickel foam before and after slurry deposition, with the active material mass being approximately 4 mg.

In an implementation, the working electrode is subjected to a surface activation process involving immersion in 0.5M HCl for 2-3 minutes prior to slurry deposition, wherein the nickel foam substrate has a porosity in the range of 90-95%, and wherein the mass loading of the active material is controlled within a tolerance of +0.1 mg, and wherein the Ag/AgCl reference electrode is coated with a layer of Nafion to prevent contamination, wherein the platinum counter electrode has a surface area of at least 1 cm², and wherein the working electrode is preconditioned with cyclic voltammetry in the range of 0-1V for 10 cycles before testing.

In an implementation, the electrolyte is prepared using ultrapure water with a resistivity of at least 18.2 MΩ·cm, wherein the 1M KOH solution is degassed under vacuum for 30-60 minutes before use, and wherein the electrochemical testing unit includes an automated temperature control system to maintain the testing temperature within +1° C. of the setpoint. In an embodiment, preparation of the electrolyte comprises using ultrapure water with a resistivity of at least 18.2 MΩ·cm. The high resistivity of the ultrapure water ensures that it contains minimal impurities, which could otherwise interfere with the electrochemical reactions within the system. Using ultrapure water is essential for minimizing the introduction of ions or other contaminants that could negatively affect the performance of the electrochemical system. The resistivity threshold of 18.2 M∩·cm ensures that the water is of sufficient purity to be used in sensitive electrochemical testing applications, ensuring reliable and reproducible results.

The hybrid supercapacitor utilizing a two-electrode system using the process for electrochemical characterization is disclosed. The system comprising an anode constructed of activated carbon (AC), a cathode constructed of Nd-PTA-MOF material, an electrolyte comprising 1M KOH solution, and a controller configured to calculate mass loading of the electrodes, wherein the controller further calculates specific capacitance, specific capacity, energy density, and power density.

Additionally, the 1M potassium hydroxide (KOH) solution used as the electrolyte is degassed under vacuum for 30-60 minutes before use. Degassing the solution removes dissolved gases, particularly oxygen and carbon dioxide, which can affect the electrochemical behavior of the electrolyte and the electrode materials. The removal of these gases helps to eliminate unwanted side reactions, such as the reduction of oxygen, which could distort the testing results and affect the accuracy of measurements like capacitance and charge/discharge performance. By degassing the electrolyte solution, the system ensures that the electrochemical testing reflects the true behavior of the electrodes under ideal conditions.

Finally, the electrochemical testing unit is equipped with an automated temperature control system that maintains the testing temperature within +1° C. of the setpoint. Temperature control is critical in electrochemical testing, as temperature fluctuations can significantly affect the rate of electrochemical reactions, as well as the conductivity and performance of the electrolyte and electrode materials. By maintaining the temperature within a tight tolerance, the system ensures that the electrochemical testing is consistent and that the results are not skewed by temperature-induced variability. The automated temperature control system allows for precise regulation, ensuring that testing conditions are optimal and reproducible for reliable and accurate performance data.

In the present invention, the Nd-PTA-MOF is synthesized by using neodymium nitrate hexahydrate and pyridine-2,4,6-tricarboxylic (PTA) acid via reflux method and the material is structurally characterized via single-crystal x-ray diffraction (XRD), fourier-transform infrared spectroscopy (FT-IR) and thermogravimetric analysis (TGA). The invention revolves around the use of lanthanide metal and organic linker with nitrogen atom to improve the electrochemical properties. To delve the electrochemical attributes of the material various electroanalytical techniques such as cyclic voltammetry (CV), galvanic charge-discharge (GCD) and electrochemical impedance spectroscopy (EIS) are utilized. Three-electrode assembly with 1M KOH shows appreciable energy storage performance so practical applications of the material are explored by fabricated it against the activated carbon. This hybrid device shows considerable specific capacity, energy density and power density with extra-ordinary stability which suggests that dual function Nd-PTA-MOF is an efficient contender for futuristic energy storage devices.

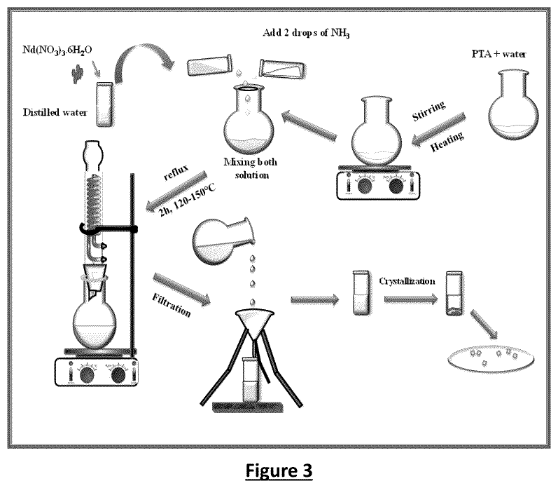

FIG. 3 illustrates a schematic illustrations for the synthesis of Nd-PTA-MOF by using reflux method in accordance with an embodiment of the present disclosure.

### Materials:

Neodymium (III) nitrate hexahydrate (Nd (NO₃)₃·6H₂O), pyridine-2,4,6-tricarboxylic acid (PTA), ethanol, deionized water, potassium hydroxide (KOH), N-methyl-2-pyrolidine (NMP), poly-vinylidene fluoride (PVDF) were brought from Sigma-Aldrich. Since all the compounds utilized to create MOF were analytical grade chemicals and used without further purification. The Ag/AgCl and platinum wire, which function as the reference and counter electrodes, respectively.

Synthesis of MOF based on Neodymium (Nd-PTA-MOF):

Nd-PTA-MOF is synthesized by using reflux method. 0.379 mmol (166.13 mg) of neodymium nitrate hexa-hydrate is dissolved in 2 ml of distilled water and 0.379 mmol (80 mg) of pyridine-2,4,6-tri-carboxylic acid is dissolved in 5 ml of distilled water in round bottom flask with magnetic stirring while heating. After mixing both the solutions in round bottom flask, two drops of liquid NH₃ was added and the whole mixture is refluxed for 2 hours at 120-150° C. This mixture gives purple color crystals of Nd-PTA-MOF after seven days which were washed with distilled water and acetone. FIG. 3 gives the schematic illustration for the synthesis of the Nd-PTA-MOF by using reflux method.

### Crystallographic Data Collection and Refinement

Diffraction experiments were carried out at 293K. The following procedures were implemented in our analysis: data collection: COLLECT, cell refinement: DENZO/SCALEPACK, data reduction: DENZO/SCALEPACK: program(s) used for molecular graphics were as follows: Mercury programs: software used to prepare material for publication: WinGX. All non-hydrogen atoms were refined with anisotropic parameters.

### Electrochemical Characterization and Fabrication of Electrode:

All electrochemical tests such as linear sweep voltammetry (LSV) cyclic voltammetry (CV), galvanostatic charge-discharge (GCD) testing, electrochemical impedance spectroscopy (EIS) and cycle stability analysis were performed by using three and two electrode assemblies. The prepared electrodes, a platinum plate, and an Ag/AgCl electrode were used as the working, counter, and reference electrodes, respectively. For making working electrode, a slurry of 80% (8 mg) active material, 10% (1 mg) carbon black, and 10% (1 mg) PVDF binder was mixed in N-Methyl-2 pyrrolidone (NMP) (used as solvent). Before deposition, the slurry was completely mixed overnight using a hot plate magnetic stirrer at 350 RPM. After that, slurry was loaded onto a Nickel Foam (1 cm²) by drop casting method. The nickel foam was weighed both before and after the slurry was loaded in order to determine the quantity of active material which came as 4 mg. The prepared electrode was dried for 12 hours at 60° C. In three electrode cell, IM KOH was used as electrolyte. CV tests were carried out at various scan rates ranging and GCD tests were conducted at various current densities. EIS analysis was performed with a frequency range of 10-2 Hz to 100 KHz.

Nd-PTA-MOF//AC hybrid supercapacitor's electrochemical properties were investigated utilizing a two-electrode system in a 1 M KOH electrolyte solution. Active carbon (AC) functioned as the anode and Nd-PTA-MOF as the cathode. Equation (1) below was used to compute the mass loading on the electrode using mass balancing:

$$\frac{{m}_{+}}{{m}_{-}} = \frac{{C}_{s -} \times Δ {V}_{-}}{{C}_{s +} \times Δ {V}_{+}} \qquad ( 1 )$$

where m+ and m−, AV+ and AV−, and Cs+ and Cs− denote the active masses, potential window, and specific capacitances between the positive and negative electrodes, respectively.

$$Cs = \frac{2 I ( \int Vdt )}{m \times {V}^{2}} \qquad ( 2 )$$

$$Qs = \frac{2 I \times \int Vdt}{m \times V} \qquad ( 3 )$$

$$Es = \frac{I \times \int Vdt}{m \times 3.6} \qquad ( 4 )$$

$$P = \frac{E \times 3600}{{t}_{d}} \qquad ( 5 )$$

Equations 2 to 5 are used to calculate the following: specific capacity (Qs, C/g), specific capacitance (Cs, F/g), energy density (Es, Wh/kg), and power density (Ps, W/kg). Where (i/m) indicates current density, AV represents the potential window and ta indicates discharge duration.

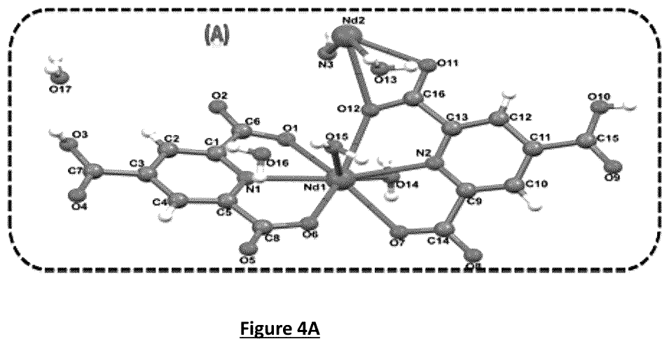

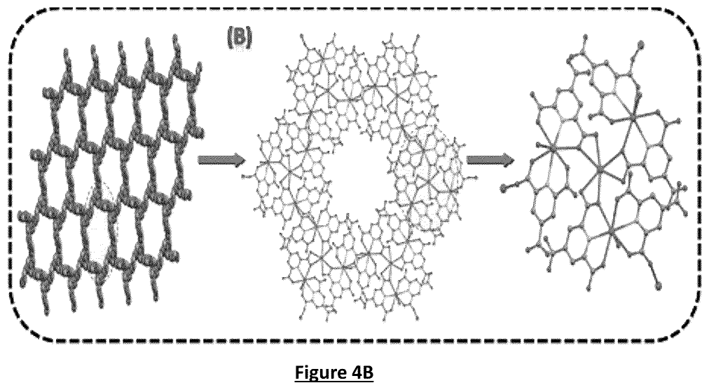

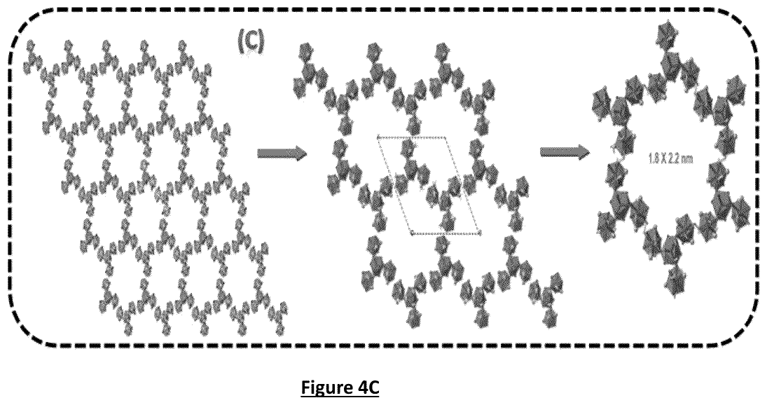

FIG. 4A illustrates a molecular structure of complex showing the atom numbering scheme. FIG. 4B illustrates a schematic view of 3D propagation in complex. FIG. 4C illustrates a schematic polyhedral.

### FTIR, Elemental & Thermogravimetric (TGA) Analysis

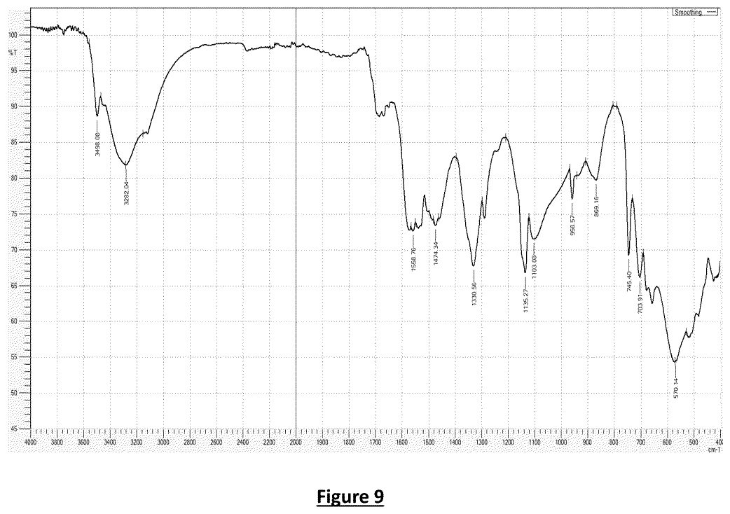

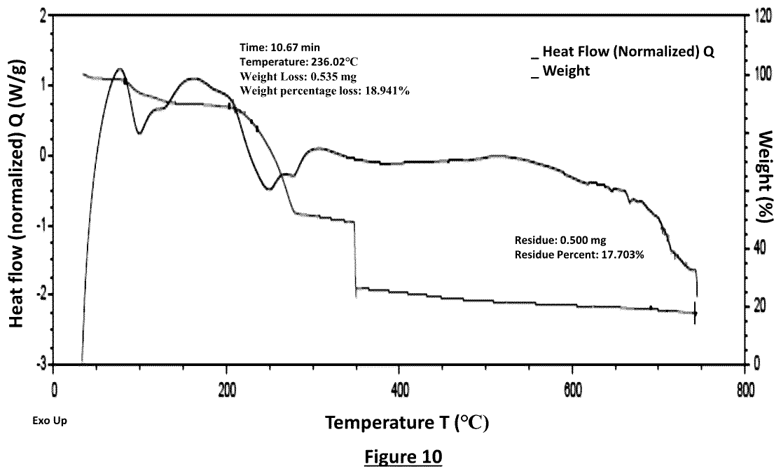

FTIR and TGA analysis further confirmed the binding of metal with ligand and results have been discussed and presented in supplementary material (FIGS. 9 and 10).

### Single-Crystal Structure of Nd-PTA-MOF

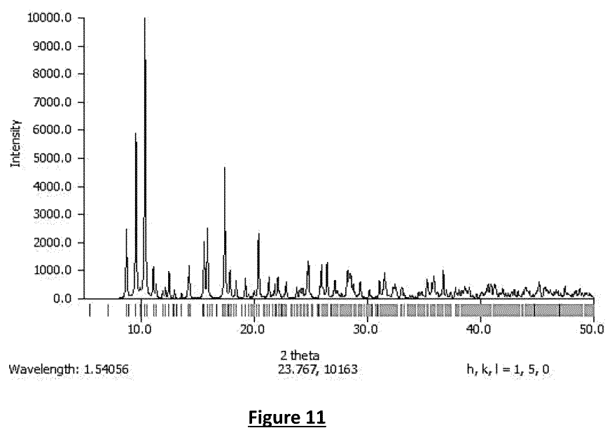

The molecular structure of the complex is depicted in FIG. 4A with the atomic numbering scheme. The asymmetric unit of the complex consists of two Nd(III) ions, three coordinated water molecules, two non-coordinated water molecules, one ammonia molecule and two pyridine-2,4,6-tricarboxylic (ptc) ligands. The Nd(III) ions are of two coordination types. In the first of these coordinations, the Nd1 atom is nine-coordinated by two nitrogen atoms (N1 and N2) from two pyridine rings, five oxygen atoms (O1, O6, O7, O12 and O51) from five carboxylic groups and two oxygen atoms (O14 and O15) from water molecules. The Nd2 and N3 atoms located on 3-fold symmetry centers. In the second coordination, the Nd2 atom is ten-coordinated by six oxygen atoms (O11, O12, O11ⁱⁱ, O12ⁱⁱ, O11ⁱⁱⁱ and O12ⁱⁱⁱ) from three carboxylic groups, three oxygen atoms (O13, O13ⁱⁱ and O13ⁱⁱⁱ) from water molecules and one nitrogen atom (N3) from ammonia molecule ((i) −x, −y+1, z+½: (ii) −y+1, x−y+1, z: (iii) −x+y, −x+1, z). Complex reveals a 3D layer coordination arrangement (FIG. 4B), which has a similar network as the previously reported [Nd(ptc)·2H₂O] · 2H₂O complex. Schematic view of 3D propagation is illustrated in FIG. 4B. The adjacent Nd1 . . . . Nd2, Nd1 . . . Nd1^{x} and Nd1 . . . . Nd1ⁱⁱ distances in the 3D chain are 5.134, 6.628 and 8.249 Å, respectively. The bond distances of Nd—O_{water} ranged between 2.459 (11)-2.547 (11) Å and that of Nd—O_{carboxylate} ranged between 2.453 (9)-2.803 (9) Å, respectively. The Nd—N bond distances [2.588 (9), 2.652 (10) and 2.39 (2) Å], are comparable with some known Nd(III) complexes. The N—Nd—N bond angle is 153.4 (4)°, respectively. The bond angles of O—Nd—O ranged between 49.8(3)-147.7(3) °, respectively. The pyridine ring mean planes from are approximately planar, with maximum deviations of 0.0206 (91) Å for Cl atom and 0.0142 (84) Å for C13 atom, respectively. A noticeable feature of complex is the presence of intermolecular O—H . . . O, O—H . . . . N and N—H . . . O hydrogen bonds in the molecular packing. The O . . . N and N . . . O distances are 3.26(2) and 2.804 (13) Å, respectively. The O . . . O distances range from 2.442 (14) to 3.29 (2) Å, respectively. These hydrogen bonds play a major role in constructing network polymers. Simulated XRD diffractogram of Nd-PTA-MOF is shown in FIG. 11.

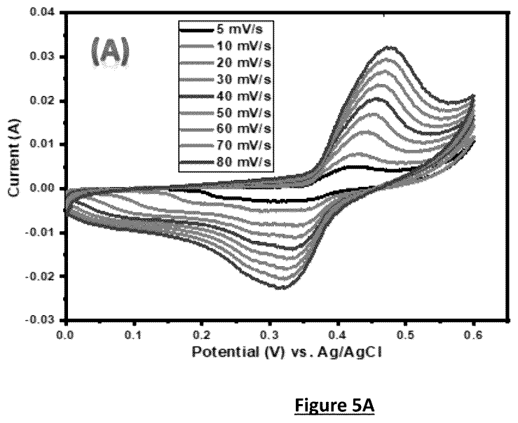

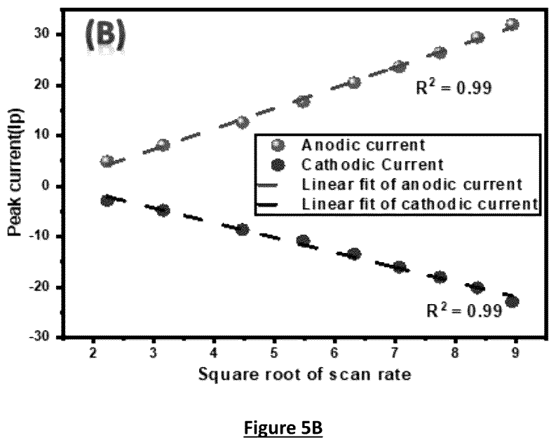

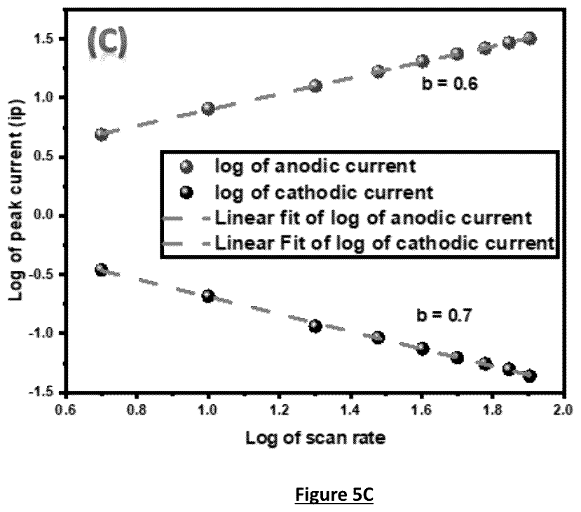

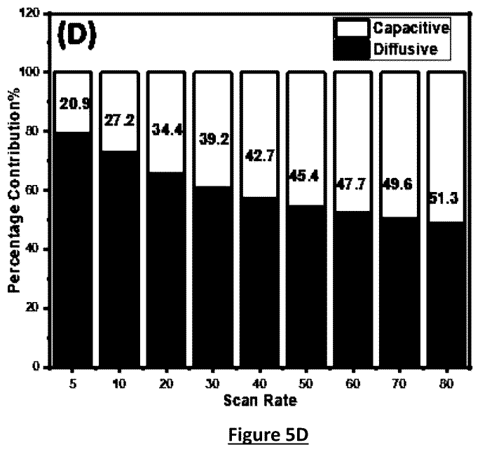

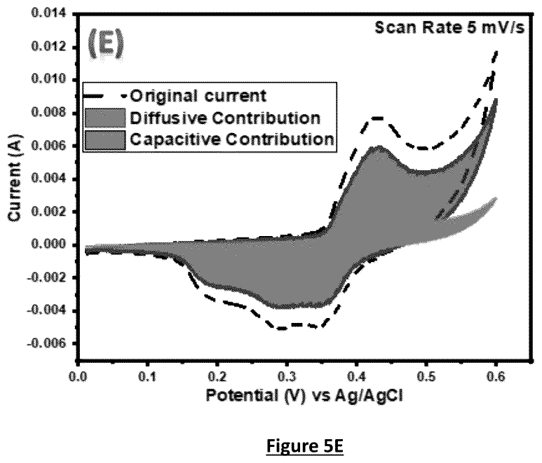

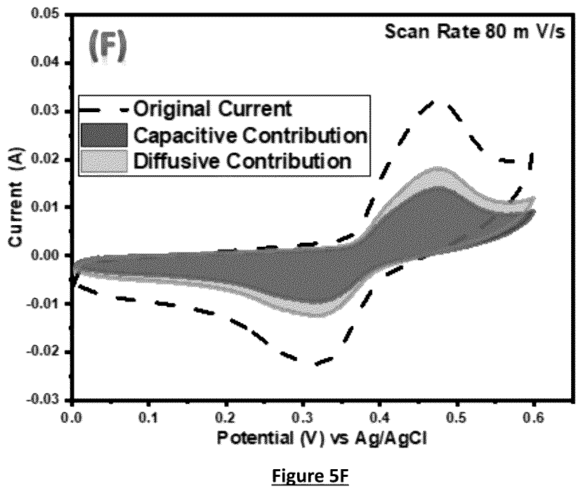

FIG. 5A illustrates CV of Nd-PTA-MOF at various scan rates. FIG. 5B illustrates R2 value of Nd-PTA-MOF. FIG. 5C illustrates Graph of linear fitting between log of peak current (ip) and log of scan rate. FIG. 5D illustrates Percentage of capacitive and diffusive contribution showing by bar graph. FIG. 5E illustrates Diffusive and capacitive contribution of Nd-PTA-MOF at scan rate of 5 mV/s. FIG. 5F illustrates Diffusive and capacitive contribution of Nd-PTA-MOF at scan rate of 80 mV/s.

### Electrochemical Characterization:

### Half Cell Electrochemical Analysis

### Cyclic Voltammetry:

Significant information about the Nd-PTA-MOF electrochemical properties can be obtained using cyclic voltammetry. Cyclic voltammograms were carried out at various scan rates (5, 10, 20, 30, 40, 50, 60, 70 and 80 mV/s) within the potential window of 0V to 0.6V. The CV curves of Nd-PTA-MOF showed clearly defined redox peaks that illustrated the features of faradaic redox reactions and the material's usual pseudo-capacitor type behavior. The continuing faradaic reactions between the electrode and electrolyte interface were clearly illuminated by the presence of anodic and cathodic peaks in the voltammograms. These peaks showed that the materials could undergo reversible redox reactions and were electrochemically active. The strong catalytic activity of the electrode material during the charge storage mechanism is indicated by the redox peaks that are close to one another. Moreover, the type of reaction occurring at the electrode can be predicted by looking at the peak current of the oxidation and reduction peaks.⁴⁷ The pore size of 1.8×2.2 nm as compared to hydroxide ions (HO⁻) with ionic radius of 0.110 nm facilitates intercalation of ions to the redox active metal center. Additionally, FIG. 5A shows how the anodic and cathodic peaks enhance towards high and low potential, respectively, as the scan rates increase. The fact that the peaks in the CV curves held their shape should be noted as it suggests a higher-quality pseudo-capacitor type material with excellent stability and rate capabilities. The anodic and cathodic peaks for the Nd-PTA-MOF are shown in FIG. 5B. The linear relationship that was found makes it evident how the material show diffusion properties for charge storage It is evident that R2 values are close to 1, indicating the material's reversible qualities, which is one of the features of pseudocapative type material. For understanding the nature of charge-storage mechanism, the b value plays important role which is found by the following equations (6-7).

$$i = a {v}^{b} \qquad ( 6 )$$

$$log ( i ) = log ( a ) + b log ( v ) \qquad ( 7 )$$

In the above equation, ‘a’ and ‘b’ are the adjustable constant, ‘i’ and ‘v’ represent the current and scan rate, respectively. FIG. 5C represents the log of anodic and cathodic current versus log of scan rate to get the b value and compare it with the theoretical b value. While battery-like materials have b-values in the 0-0.5 range and capacitors have b-values of 0.8 to 1. Nonetheless, the supercapacitor is responsible for b-values that lie between 0.5 and 0.8. Measured b value is around about 0.7 which confirm the supercapacitor type material.

Kinetic mechanisms that distinguish between diffusive and capacitive processes can be investigated using Dunn's equation (Eq. 8).

$$i ( V ) = {k}_{1} v + {k}_{2} {v}^{1 / 2} \qquad ( 8 )$$

In above equation, ‘i’ and ‘y’ denote the peak current and scan rate respectively, and the diffusive controlled reaction is denoted by k₂v^{1/2}, whereas the rapid surface capacitive effect is represented by k₁v. The capacitive contribution at the scan rate of 5 mV/s was 20.1% which is increased to 51.3% at the scan rate of 80m V/s and the diffusive contribution at the scan rate of 5 mV/s was 79.9% which is decreased to 48.7% at the scan rate of 80 mV/s is shown in FIG. 5D. The diffusive (in blue) and capacitive (in red) contributions at scan rate of 5 mV/s are shown in FIG. 5E. The diffusive (in blue) and capacitive (in red) contributions at scan rate of 80 m V/s are shown in FIG. 5F.

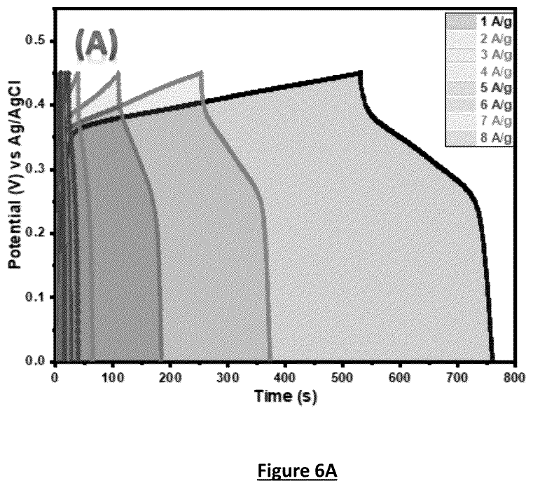

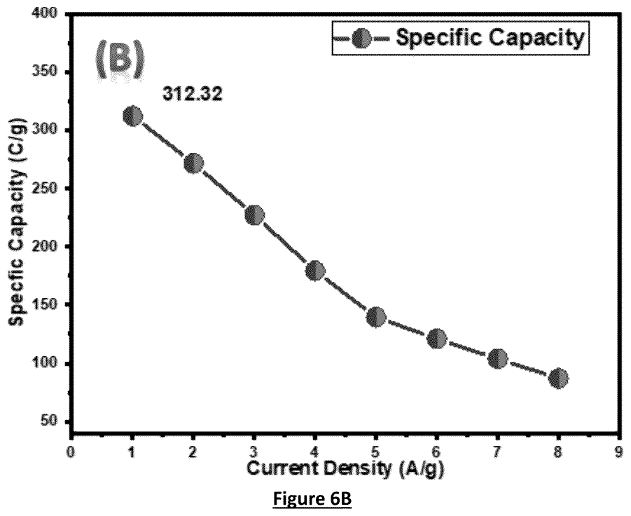

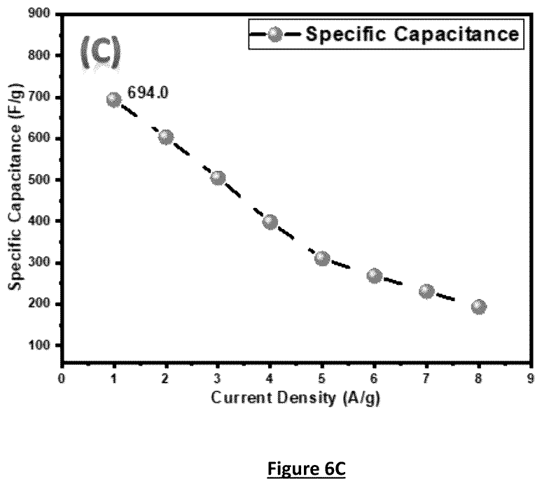

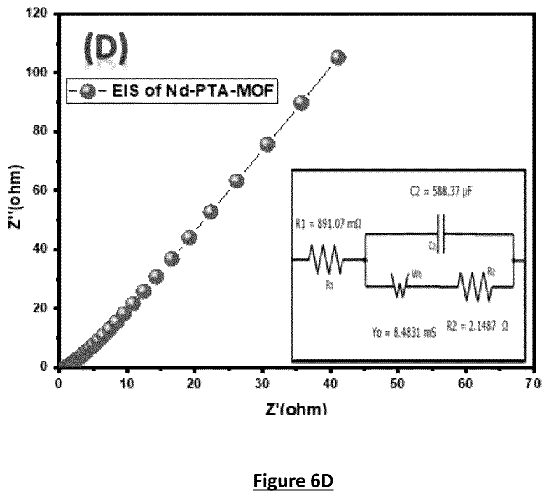

FIG. 6A illustrates GCD of Nd-PTA-MOF at various current densities (0.75-7 A/g). FIG. 6B illustrates Relationship of specific capacities with different current densities. FIG. 6C illustrates Relationship of specific capacitances with different current densities. FIG. 6D illustrates EIS of Nd-PTA-MOF in accordance with an embodiment of the present disclosure.

To gain greater insight into the energy storage characteristics of Nd-PTA-MOF, GCD tests were carried out within potential 0V-0.45V at different current densities. (1, 2, 3, 4, 5, 6, 7 and 8 A/g) which showed the pseudo-capacitor type material. However, in recent years, most electroactive materials have been studied to display the battery type non-linear characteristics during GCD analysis in alkaline electrolyte. Up to now, only faradaic electroactive structures have been identified and studied for pseudocapacitive applications. Charge-Discharge cycles of Nd-PTA-MOF within potential window of 0V-0.45V at various current densities ranging from 0.75 A/g-7 A/g are shown in FIG. 6A. During GCD study, it was found that when current densities increases, there is reduction in discharge duration, the discharge plateaus remain similar that shows the material's stability at greater current densities. This decrease in discharge time could be the result of hydroxyl ions having enough time to enter the electrode material at low current density and occupy the redox active spots for ionic adsorption. The Nd-PTA-MOF showed specific capacity of 312.23 C/g at current density of 1 A/g which shows decrease when current density increased. The GCD curves demonstrate the pseudo-capacitor type performance of Nd-PTA-MOF and agree with the observed CV results. FIG. 6B shows the relation between current densities and specific capacities derived from GCD curves. FIG. 4C shows the relation between current densities and specific capacitances derived from GCD curves.

### Electrochemical Impedance Spectroscopy:

Improved electrochemical approach called electrochemical impedance spectroscopy (EIS) makes it possible to distinguish between various electrical, physical in nature, and electrochemical reactions that take place in electrochemical systems. The ability to differentiate between a variety of phenomena, such as mass transfer and diffusion of redox species towards electrode surface, charging and discharging of electrical double layer at electrode-electrolyte interface, capacitive behavior of electrical double layer on electrode and electrolyte nature, and charge transfer reaction kinetics on electrode, is made possible by the time-dependent nature of these reactions and the resistances they produce. The EIS tests were carried out at the frequency range of 0.01-100 KHz at alternating current (AC) in three electrode assembly for knowing about the conductivity of Nd-PTA-MOF and to observe the kinetics that is happened on the electrode surface. The point of contact on the x-axis close to the high frequency zone represents the equivalent series resistance (ESR). ESR can be calculated by the Nyquist plot. The ESR value for Nd-PTA-MOF is 0.8Ω that is very low value which indicates that the material show strong conductivity. The lack of semicircle formation, which ultimately demonstrates the improved conductivity, means that the Nd-PTA-MOF charge transfer resistance is essentially non-existent. The Rct value for Nd-PTA-MOF is 2.14Ω. The lower frequency straight line formation can be attributed to the diffusion of hydroxyl ions into the active material. Warburg impedance is seen by the vertical line of Nd-PTA-MOF at lower frequencies. FIG. 6D shows the EIS plot for the Nd-PTA-MOF.

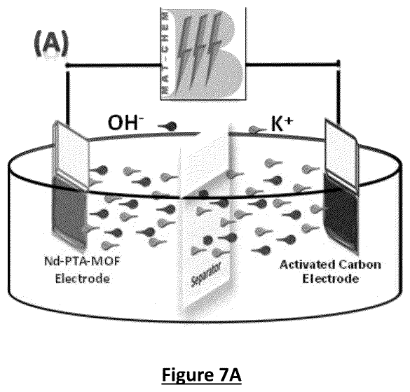

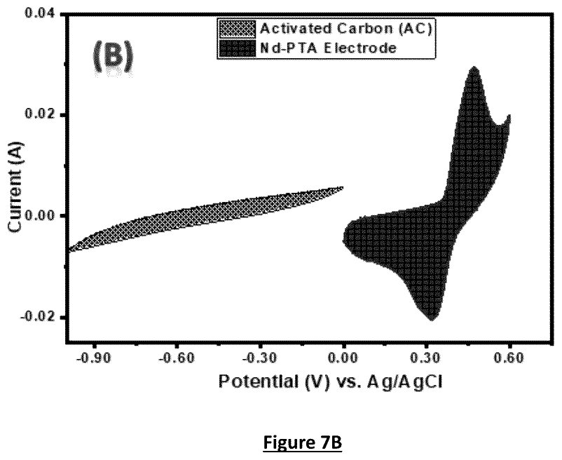

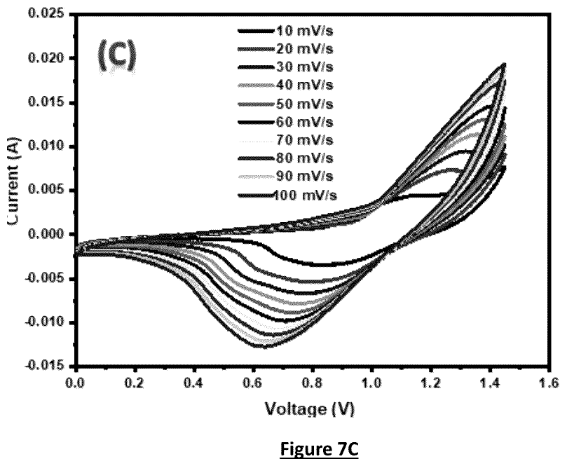

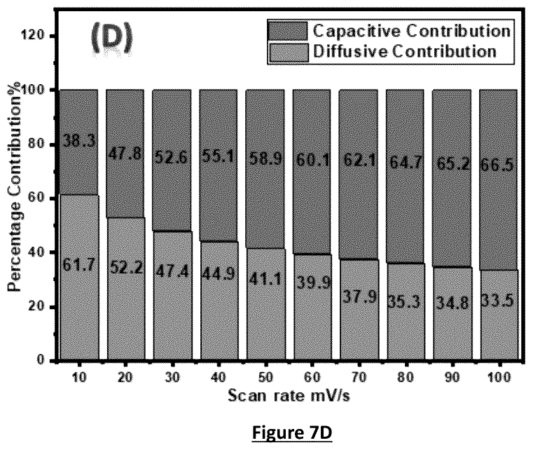

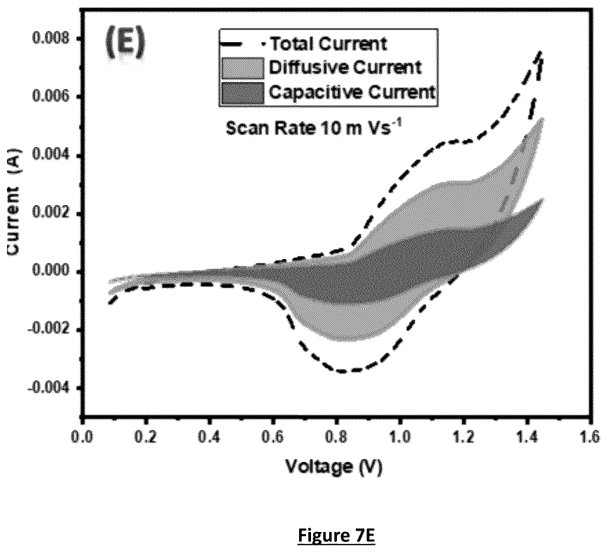

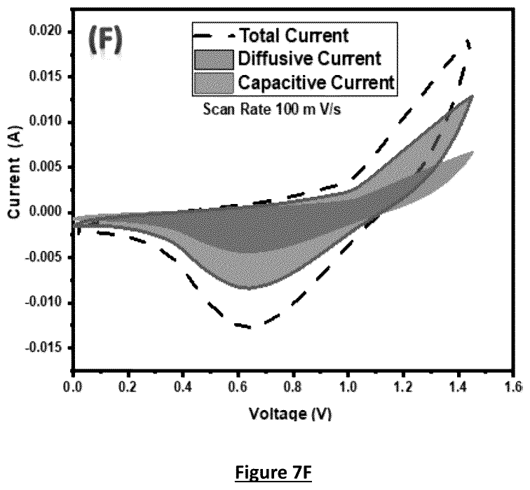

FIG. 7A illustrates Schematic representation of the assembled hybrid device. FIG. 7B illustrates CV's of Nd-PTA-MOF and AC electrodes, individually. FIG. 7C illustrates CV of Nd-PTA-MOF//AC at various scan rate. FIG. 7D illustrates Bar graph showing percentage contribution of diffusive and capacitive contribution. FIG. 7E illustrates Diffusive and capacitive contribution of Nd-PTA-MOF//AC at the scan rate of 10 mV/s. FIG. 7F illustrates Diffusive and capacitive contribution of Nd-PTA-MOF//AC at the scan rate of 100 mV/s in accordance with an embodiment of the present disclosure.

### Battery Supercapacitor Hybrid Assembly:

By creating a hybrid supercapacitor, the practical applicability of the Nd-PTA-MOF electrode was confirmed, and schematic representation of the assembled hybrid device is shown in FIG. 7A.

For the device, activated carbon (AC) is used as negative electrode within potential window of −IV-0.0V and Nd-PTA-MOF is used as positive electrode. Combined CVs of AC and Nd-PTA-MOF is represented in FIG. 7B which suggested the potential window from 0V-1.4V. For the sake of study of electrochemical performance of assembled hybrid device. CV tests were performed at wide range of scan rate (10, 20, 30, 40, 50, 60, 70, 80, 90 and 100 mV/s) and their results are represented in FIG. 7C. Given that a hybrid device combines two different storage mechanisms, its CV curves have a quasi-rectangular form and show deviation during elevated scan rates. This deviation from the usual rectangular geometry is due to the limiting of ion transport during redox reactions on the electrode surface at high scan rates. Moreover, the bigger bumps on the curves suggest the presence of faradaic chemical processes, but the absence of more peaks suggests that the device is mostly capacitive.

Dunn's method was used to distinguish between the diffusive and capacitive controlled contributions of Nd-PTA-MOF//AC, and it was found that the capacitive behavior increased as the scan rate increased. The diffusive contribution at the scan rate of 10 mV/s was 61.7% which is decreased to 33.5% at the scan rate of 100m V/s and the capacitive contribution at the scan rate of 10 mV/s was 38.3% which is increased to 66.5% at the scan rate of 100m V/s as shown in FIG. 7D. The capacitive (in green) and diffusive (in orang) contributions at 10 mV/s are shown in FIG. 7E and the capacitive (in green) and diffusive (in orang) contributions at 100 mV/s are shown in FIG. 7F.

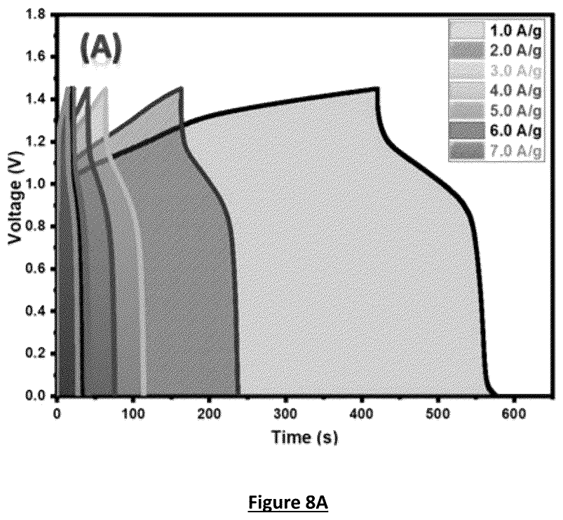

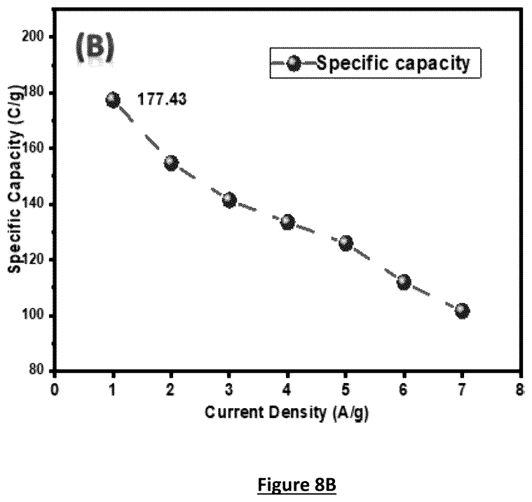

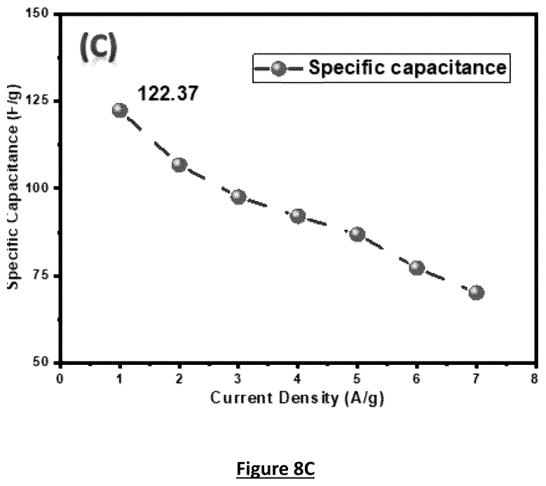

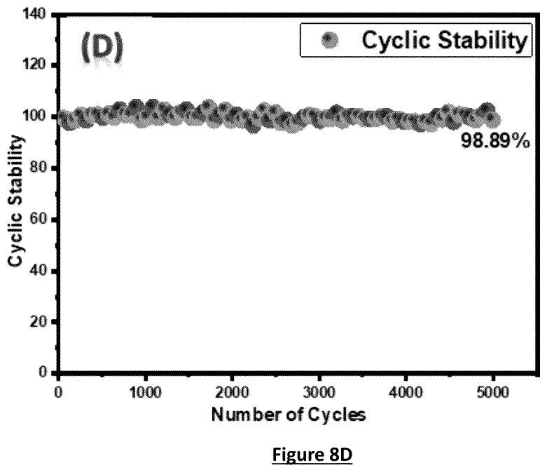

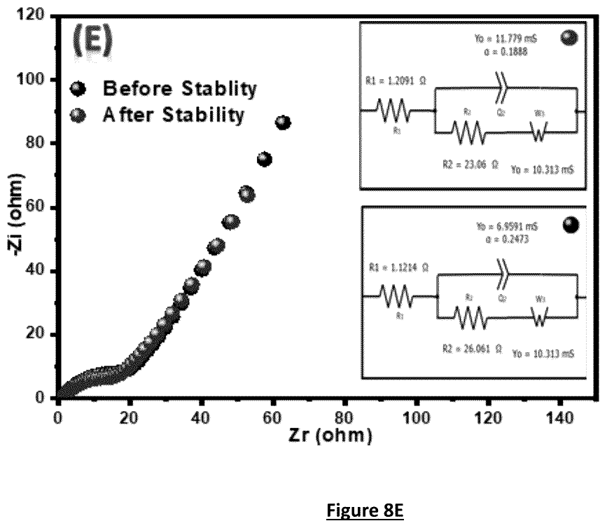

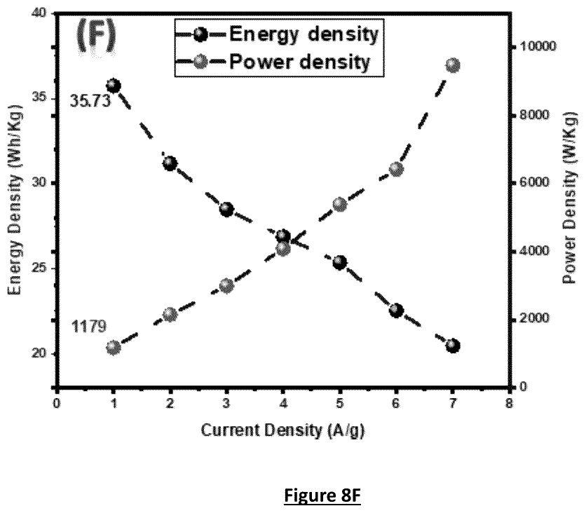

FIG. 8A illustrates GCD of hybrid device (Nd-PTA-MOF//AC) with different current densities. FIG. 8B illustrates Comparison of specific capacities and current densities. FIG. 8C illustrates Comparison of specific capacities and current densities. FIG. 8D illustrates Number of cycles versus Coulombic efficiency of Nd-PTA-MOF//AC hybrid device. FIG. 8E illustrates EIS Spectrum of Nd-PTA-MOF//AC before stability and after stability. FIG. 8F Comparison of energy densities and power densities at various current densities in accordance with an embodiment of the present disclosure.

GCD curves of Nd-PTA-MOF//AC were performed at various current densities (1, 2, 3, 4, 5, 6 and 7 A/g) within potential window of 1.45V and their results are shown in FIG. 8A, which confirms the supercapattery device and agree with CV results. The maximum specific capacity value is obtained as 177.43 C/g at the current density of 1 A/g (FIG. 8B) and the specific capacity of the device declines as the current density increases. FIG. 8C shows the relationship between specific capacitances and current densities. The durability and stability test of the device is crucial in determining the life space of the hybrid device. When the device was run to 5000 GCD cycles, it showed coulombic efficiency of 98.89% (FIG. 8D). The hybrid supercapacitor device demonstrated a maximum energy density of 35.73 Wh/kg and a power density of 1179 W/kg at current density of 1 A/g.

The hybrid device's better performance and electrical conductivity were demonstrated by the EIS studies. FIG. 8E shows EIS plots before and after stability for the Nd-PTA-MOF//AC. Before stability, the supercapattery's ESR value is 1.2152. After 5000 cycles, the device tests and displays an extremely low ESR value of 1.12 (2. The straight vertical line at lower frequencies indicates the hydroxyl ions diffusion in the electrode, indicating the better capacitive nature of the device, and the very small semicircles diameters in the Nyquist plot show low charge transfer resistance. The Nd-PTA-MOF/AC hybrid device's results are convincing for its use as a hybrid supercapacitor device. FIG. 8F illustrates the relationship between power density and energy density.

FIG. 9 illustrates FTIR spectra of Gd-PDA-MOF in accordance with an embodiment of the present disclosure.

FIG. 10 illustrates TGA of Gd-PDA-MOF in accordance with an embodiment of the present disclosure.

FIG. 11 illustrates Simulated XRD diffractogram of Gd-PDA-MOF in accordance with an embodiment of the present disclosure.

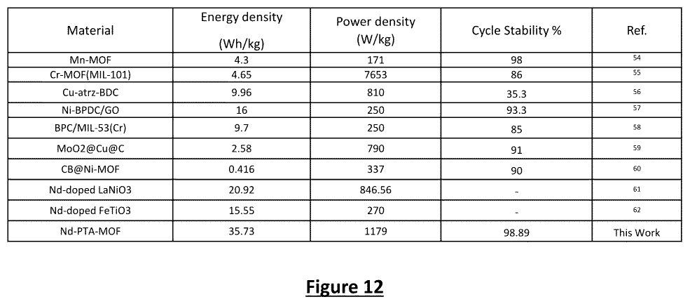

FIG. 12 illustrates a Table depicting comparative electrochemical analysis of current work with already reported materials in accordance with an embodiment of the present disclosure.

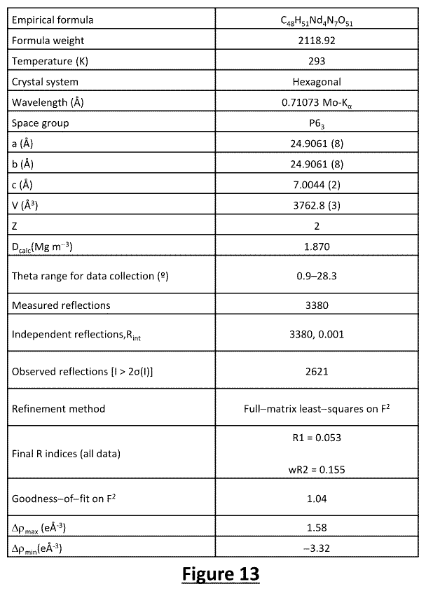

FIG. 13 illustrates a Table depicting crystal data and structure refinement parameters for complex in accordance with an embodiment of the present disclosure.

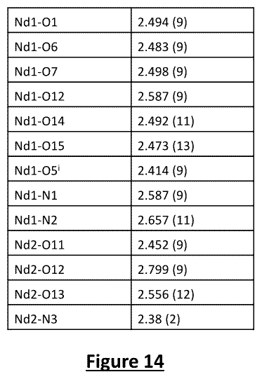

FIG. 14 illustrates a Table depicting selected bond distances in the complex (A) in accordance with an embodiment of the present disclosure.

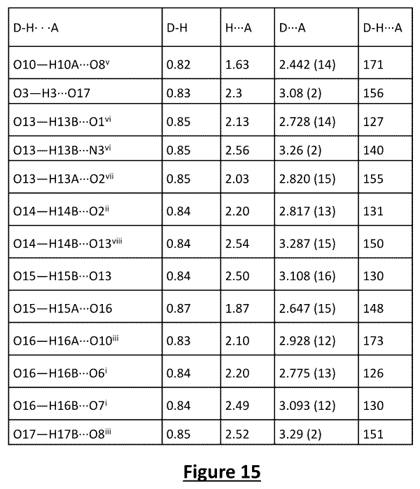

FIG. 15 illustrates a Table depicting Hydrogen-bond parameters for complex (A, °) in accordance with an embodiment of the present disclosure.

In the present invention, a special metal organic framework has been designed that could be used in supercapattery technology The Nd-PTA-MOF was synthesized from neodymium nitrate hexahydrate and pyridine-2,4,6-tricarboxylic acid via reflux method. The material was characterized by using X-Ray Diffraction (XRD) and FT-IR techniques. The electrochemical properties have been investigated using three electrode assemblies using CV, GCD, and EIS methods. Nd-PTA-MOF showed the specific capacity of 312.32 C/g at the current density of 1 A/g. Furthermore, Nd-PTA-MOF was chosen for the hybrid device by combining it with activated carbon. Dunn's method was used to explore the capacitive-diffusive contribution. The hybrid device showed the specific capacity of 177.43 C/g at the current density of 1 A/g and maximum energy density of 35.73 Wh/kg and power density of 1179 W/kg at current density of 1 A/g. The hybrid device demonstrated exceptional coulombic efficiency of 98.89% even after 5000 GCD cycles. Nd-PTA-MOF has been employed as a novel material to create high-performance supercapattery devices.

### Acknowledgement

The authors extend their appreciation to University Higher Education Fund for funding this research work under Research Support Program for Central labs at King Khalid University through the project number CI/PAT/3.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above about specific embodiments. However, the benefits, advantages, solutions to problems, and any component(s) that may cause any benefit, advantage, or solution to occur or become more pronounced are not to be construed as a critical, required, or essential feature or component of any or all the claims.

1. A process for synthesizing neodymium-based metal-organic frameworks (Nd-PTA-MOF) for fabricating an electrode, comprising:
dissolving 166.13 mg of neodymium nitrate hexa-hydrate in 2 ml of distilled water to form a first solution;
dissolving 80 mg of pyridine-2,4,6-tri-carboxylic acid (PTA) in 5 ml of distilled water to form a second solution;
mixing the first solution and the second solution in a round bottom flask with magnetic stirring while heating;
adding two drops of liquid ammonia to the mixture;
refluxing the mixture for 2 hours at a temperature in the range of 120-150° C.;
allowing the mixture to crystallize over a period of seven days to form purple-colored Neodymium pyridine-2,4,6-tricarboxylate coordination complex (Nd-PTA-MOF) crystals;
washing the formed Nd-PTA-MOF crystals with distilled water and acetone; and
fabricating the electrode for developing a hybrid supercapacitor.

2. The process of claim 1, wherein the refluxing is performed using a specific heating apparatus capable of maintaining the temperature range of 120-150° C.

3. The process of claim 1, wherein the addition of liquid ammonia adjusts the reaction mixture's pH, facilitating the formation of Nd-PTA-MOF.

4. The process of claim 1, wherein the fabricating of the electrode, comprises the steps of:
preparing a slurry comprising 80% active material comprising Neodymium pyridine-2,4,6-tricarboxylate coordination complex (Nd-PTA-MOF) crystals as claimed in claim 1, 10% carbon black, and 10% PVDF binder mixed in N-Methyl-2 pyrrolidone (NMP) as solvent;
mixing the slurry overnight using a hot plate magnetic stirrer at 350 RPM;
loading the slurry onto Nickel Foam (1 cm²) by drop casting method;
weighing the Nickel Foam before and after loading the slurry to determine the quantity of active material; and
drying the prepared electrode for 12 hours at 60° C.

5. The process of claim 1, wherein the neodymium nitrate hexa-hydrate is dissolved in distilled water at a temperature in the range of 25-40° C., wherein the pyridine-2,4,6-tricarboxylic acid (PTA) is preheated to a temperature in the range of 50-70° C. before dissolving, and wherein the ammonia is added dropwise under continuous stirring at a rate of 1-2 drops per minute, wherein the crystallization step is carried out in a controlled environment chamber, wherein the relative humidity is maintained between 50% and 70%, and wherein the temperature is gradually reduced from 25° C. to room temperature over a period of 48-72 hours, and wherein the slurry preparation involves sequentially adding carbon black to the active material before introducing the PVDF binder, wherein the PVDF binder is dissolved in NMP at a concentration of 8-12% by weight, and wherein the final mixture is subjected to ultrasonication for 15-30 minutes to ensure homogeneity.

6. The process of claim 1, wherein the refluxing is performed in a closed-loop reflux apparatus equipped with a reflux condenser, wherein the apparatus is purged with nitrogen gas prior to heating, and wherein the temperature gradient across the reaction mixture is maintained within ±5° C. of the set range, and wherein the neodymium nitrate hexa-hydrate is sourced with a purity of at least 99.9%, wherein the pyridine-2,4,6-tricarboxylic acid is recrystallized from ethanol before use, and wherein the distilled water used in the synthesis has a conductivity below 2 μS/cm.

7. The process of claim 1, wherein the refluxing is performed using a heating apparatus with a temperature controller, wherein the temperature is maintained within a tolerance of ±3° C., and wherein the reflux condenser has a cooling capacity sufficient to maintain condensation of all evaporated solvent within the set range of 120-150° C., and wherein the heating is applied gradually at a rate of 1-2° C. per minute to avoid sudden temperature changes, and wherein the apparatus is equipped with an inert gas inlet to ensure an oxygen-free environment during the reaction.

8. The process of claim 1, wherein the crystallization occurs in a darkened chamber to prevent photodegradation of the Nd-PTA-MOF, wherein the chamber temperature is maintained at 25° C. for the first 24 hours, and wherein the humidity level within the crystallization chamber is controlled with a dehumidifier to maintain a constant relative humidity of 60%, and wherein the crystallized Nd-PTA-MOF is gently washed with distilled water followed by acetone to remove any residual solvent, and wherein the washed crystals are dried under a stream of nitrogen gas at room temperature for 6-8 hours.

9. The process of claim 1, wherein the slurry preparation further comprises the addition of a small quantity of a conductive additive selected from the group consisting of graphene oxide and carbon nanotubes, wherein the conductive additive is added at a concentration between 1% and 5% by weight, and wherein the slurry is heated at 50° C. during mixing to reduce the viscosity of the solvent, and wherein the mixture is subjected to an ultrasonic treatment at a frequency of 20-40 kHz for 15 minutes to enhance dispersion of the active material, and wherein the PVDF binder is added dropwise to the slurry to prevent premature gelation.

10. The process of claim 1, wherein the electrode fabrication further comprises the step of compressing the loaded Nickel Foam after drying, wherein the compression is applied at a force of 50-100 N for 5 minutes to ensure uniform contact between the active material and the substrate, and wherein the electrode is then subjected to a thermal treatment at 80° C. for 2 hours under vacuum to remove any residual solvents, and wherein the final electrode is characterized by a surface area greater than 1.2 cm², and wherein the specific capacitance of the electrode is tested in a two-electrode configuration using an aqueous electrolyte.

11. The process of claim 1, wherein the addition of liquid ammonia is done in small portions, wherein each portion is added every 2-3 minutes, and wherein the pH of the reaction mixture is monitored continuously using a pH meter to ensure a final pH of 7.0-7.5, and wherein the pH adjustment ensures the formation of a well-structured Nd-PTA-MOF, and wherein the ammonia solution is prepared fresh prior to use, and wherein the ammonia is of analytical grade with a purity of at least 99%.

12. The process of claim 1, wherein the distilled water used in the synthesis is filtered through a 0.22 μm membrane filter to remove any particulate matter, and wherein the temperature of the distilled water is kept constant during dissolution at 30° C. using a water bath, and wherein the neodymium nitrate hexa-hydrate is dissolved slowly to avoid localized overheating, and wherein the pyridine-2,4,6-tricarboxylic acid (PTA) solution is stirred at 400 RPM for at least 30 minutes to ensure complete dissolution before the second solution is added.

13. A process, comprising:
fabricating the electrode using the process of claim 1 to generate the electrode to comprise:
80% active material comprising Neodymium pyridine-2,4,6-tricarboxylate coordination frameworks (Nd-PTA-MOF);
10% carbon black;
10% polyvinylidene fluoride (PVDF) binder; and
N-Methyl-2 pyrrolidone (NMP) as solvent, wherein the components are mixed to form a slurry.

14. The process of claim 13, wherein the neodymium-based metal-organic frameworks (Nd-PTA-MOF), comprising:
a powder extract of neodymium nitrate hexa-hydrate, from 160-170 mg, in 1-4 ml of distilled water;
a powder extract of pyridine-2,4,6-tri-carboxylic acid (PTA), from 70-90 mg, in 4-6 ml of distilled water; and
an aqueous extract of ammonia, from 0-10 ml.

15. The process of claim 13, wherein the weight amount of the neodymium nitrate hexa-hydrate, pyridine-2,4,6-tri-carboxylic acid (PTA), and distilled water, is, 166.13 mg, 80 mg, and 7 ml, respectively.

16. The process of claim 13, wherein the carbon black has a particle size in the range of 50-100 nm, wherein the PVDF binder has a molecular weight in the range of 400,000-500,000 g/mol, and wherein the NMP solvent is used at a ratio of 5-10 ml per gram of the total solids in the slurry.

17. A process, comprising:
providing a hybrid supercapacitor system for electrochemical characterization, by:
providing a three-electrode assembly including:
fabricating the electrode using the process of claim 1, said electrode having a composition comprising 80% active material comprising Neodymium pyridine-2,4,6-tricarboxylate coordination frameworks (Nd-PTA-MOF); 10% carbon black; 10% polyvinylidene fluoride (PVDF) binder; and N-Methyl-2 pyrrolidone (NMP) as solvent;
providing a counter electrode comprising of a platinum plate;
providing a reference electrode comprising of an Ag/AgCl electrode;
providing an electrolyte comprising 1M KOH solution; and
providing an electrochemical testing unit configured to perform linear sweep voltammetry (LSV), cyclic voltammetry (CV), galvanostatic charge-discharge (GCD), electrochemical impedance spectroscopy (EIS), and cycle stability analysis.

18. The process of claim 17, wherein the working electrode comprises a nickel foam with an active material mass loading determined by weighing the nickel foam before and after slurry deposition, with the active material mass being approximately 4 mg.

19. The process of claim 17, wherein the electrode is subjected to a surface activation process involving immersion in 0.5M HCl for 2-3 minutes prior to slurry deposition, wherein the nickel foam substrate has a porosity in the range of 90-95%, and wherein the mass loading of the active material is controlled within a tolerance of ±0.1 mg, and wherein the Ag/AgCl reference electrode is coated with a layer of Nafion to prevent contamination, wherein the platinum counter electrode has a surface area of at least 1 cm², and wherein the electrode is preconditioned with cyclic voltammetry in the range of 0-1V for 10 cycles before testing.

20. The process of claim 17, wherein the electrolyte is prepared using ultrapure water with a resistivity of at least 18.2 MΩ·cm, wherein the 1M KOH solution is degassed under vacuum for 30-60 minutes before use, and wherein the electrochemical testing unit includes an automated temperature control system to maintain the testing temperature within ±1° C. of the setpoint.
